(19) United States
(12) Patent Application Publication
(10) Pub. No.: US 2026/0168776 A1
(43) Pub. Date: Jun. 18, 2026

(54) Lighted Projectile

(71) Applicant: Axon Enterprise, Inc., Scottsdale, AZ (US)

(72) Inventors: Oleg Nemtyshkin, Scottsdale, AZ (US); Magne H. Nerheim, Paradise Valley, AZ (US); Karl U. Schultz, Phoenix, AZ (US)

(21) Appl. No.: 19/513,750

(22) PCT Filed: Aug. 14, 2024
(86) PCT No.: PCT/US2024/042352

§ 371 Date: Feb. 24, 2026

Related U.S. Application Data
(60) Provisional application No. 63/519,561, filed on Aug. 14, 2023.

(51) Int. Cl. F42B 12/42; F21V 23/00; F21V 23/04; F21V 23/06; F21V 33/00; F41H 13/00; F42B 12/38; H05B 47/165

(52) U.S. Cl. CPC F42B 12/42; F21V 23/005; F21V 23/0435; F21V 23/045; F21V 23/0492; F21V 23/06; F21V 33/0076; F42B 12/382; H05B 47/165; F41H 13/0025; F41H 13/0031

(57) ABSTRACT

A lighted projectile may comprise a switch and a light source. The switch may comprise a moveable portion. The projectile may receive a propellant. The projectile may fluidly couple the propellant to the switch. The projectile may comprise a cavity by which the propellant is fluidly coupled to the moveable portion of the switch. Responsive to receiving the propellant, the moveable portion of the switch may move within the projectile. Responsive to movement of the switch, the light source may be activated. Movement of the switch may close a circuit between the light source and a power supply integrated within the projectile. The moveable portion of the switch may comprise the light source. Responsive to receiving the propellant, the projectile may be deployed from a projectile launcher. The projectile may further comprise a user interface by which a reset force may be applied to the switch to deactivate the light source.

### FIELD OF THE INVENTION

Embodiments of the present disclosure relate to a projectile.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1A is a perspective view of a projectile launcher, in accordance with various embodiments;

FIG. 1B is a perspective view of a handle and a magazine for a projectile launcher, in accordance with various embodiments;

FIG. 1C is a schematic view of a projectile launcher, in accordance with various embodiments;

FIG. 2 is a schematic view of a portion of a portion of a projectile launcher, in accordance with various embodiments;

FIG. 3A is a cross-section view of a lighted projectile, in accordance with various embodiments;

FIG. 3B is an exploded view of a lighted projectile, in accordance with various embodiments;

FIG. 4A is a cross-section view of a lighted projectile in an undeployed state, in accordance with various embodiments;

FIG. 4B is a cross-section view of a lighted projectile in a deployed state, in accordance with various embodiments;

FIG. 5A is a cross-section view of a lighted projectile in an activated state, in accordance with various embodiments;

FIG. 5B is a cross-section view of a lighted projectile in a deactivated state, in accordance with various embodiments;

FIG. 6 is a flow diagram a method of selectively emitting light from a lighted projectile, in accordance with various embodiments; and

FIG. 7 is a cross-section view of a lighted projectile, in accordance with various embodiments.

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. Furthermore, any reference to singular includes plural embodiments, and any reference to more than one component or step may include a singular embodiment or step. Reference to attached, fixed, coupled, connected, or the like may include permanent, removable, temporary, partial, full, and/or any other possible attachment option. Surface shading lines may be used throughout the figures to denote different parts but not necessarily to denote the same or different materials.

In various embodiments, a projectile launcher may be configured to launch one or more projectiles towards a target. A projectile launcher may comprise a platform, device, weapon, gun, system, and/or the like configured to deploy (or cause deployment of) a projectile. For example, a projectile launcher may comprise one or more electronic devices configured to deploy a projectile. As a further example, a projectile launcher may comprise a conducted electrical weapon (CEW), a modular conducted electrical weapon (MCEW), a payload launcher, a projectile device configured to deploy entangling projectiles, a paintball gun, and/or the like. In that regard, the projectile launcher may comprise a standalone device, a device mounted or in communication with a second device, a platform, device, or system in electronic communication with a second electronic device, and/or the like.

In various embodiments, a projectile launcher may be configured to be held and operated by a human user. For example, the projectile launcher may comprise a handle, a grip, a barrel, a stock, and/or the like configured to be held in a hand of the human user.

In various embodiments, a projectile launcher may be mounted on or proximate to a platform. In that regard, the projectile launcher may be remotely operated. For example, a human user may remotely operate the projectile launcher. The platform may comprise any suitable object, structure, or the like.

For example, in some embodiments the platform may comprise a remote vehicle. The remote vehicle may comprise any object capable of traveling by land (e.g., surfaces), water, or air. The remote vehicle may be operated by a human user. The remote vehicle may comprise an autonomous vehicle. The remote vehicle may comprise an unmanned aerial vehicle (UAV) (e.g., a drone), an unmanned ground vehicle (UGV), an unmanned surface vessel (USV) (e.g., unmanned surface vehicle, autonomous surface vehicle, etc.), a robot, a car, or the like. A ground vehicle may comprise one or more wheels, a continuous track (e.g., tank tread, caterpillar track, etc.), or the like configured to enable movement of the vehicle on land-based terrain. The remote vehicle may be operable via a separate control interface. The remote vehicle may be operable via a short-range electronic communication and/or via a long-range electronic communication. In various embodiments, the decision to remotely deploy a projectile launcher from a platform may be received directly from a human operator.

As a further example, in some embodiments the platform may comprise a static structure. The static structure may comprise a security pole, a building wall (internal or external), a wall or surface of an access control vestibule (e.g., an air lock, a mantrap, a sally port, etc.), a surface of a vehicle, a surface or exterior surface of an electronic device (e.g., a recording device, a CCTV camera, etc.), and/or the like.

A projectile launcher may be configured to launch any suitable type of projectile. For example, a projectile may include any object, payload, capsule, and/or the like configured to be deployed from a projectile launcher. For example, and in accordance with various embodiments, a projectile may comprise a non-lethal or less-lethal projectile. In that regard a projectile may comprise or be configured to deploy a dart, a paintball, a rubber projectile (e.g., a rubber bullet), a conducted electrical weapon (CEW) electrode, a modular conducted electrical weapon (MCEW) electrode or payload, an entangling projectile configured to entangle a target (e.g., a tether-based entangling projectile, a net, etc.), a scent-based projectile, a liquid-based projectile, a gas-based projectile, pepper spray or a pepper spray projectile (e.g., oleoresin capsicum, OC spray), tear gas or a tear gas cannister or projectile (e.g., 2-chlorobenzalmalononitrile, CS spray), and/or any other non-lethal or less-lethal projectile.

In various embodiments, a projectile may include a spear portion designed to pierce a surface of a target in order to at least temporarily attach the projectile to the target. For example, the projectile may comprise a training projectile with a spear portion configured to pierce a training target. Based on a location at which the training projectile attaches to the target via the spear portion, the use of a projectile launcher from which the training projectile was deployed may be evaluation. In some embodiments, a projectile may be configured to deliver an inhibitory substance (e.g., to at least partially inhibit a target). In some embodiments, a projectile may be configured to deliver a marking substance (e.g., to mark or designate a target).

In various embodiments, a projectile launcher may include a handle and one or more magazines. The handle may include one or more bays for receiving the magazine(s). The magazine(s) may be removably positioned in (e.g., inserted into, coupled to, etc.) a bay. The magazine(s) may releasably electrically, electronically, and/or mechanically couple to a bay. A deployment of the projectile launcher may launch one or more projectiles from the magazine. For example, a deployment of the projectile launcher may cause one or more projectiles to be launched toward a target. In embodiments where the projectile launcher comprises a CEW, deployment of the projectile launcher may cause one or more projectiles to be launched toward a target to remotely deliver a stimulus signal through the target.

In various embodiments, a magazine may be configured to include, hold, or receive one or more projectiles. A magazine may include two or more projectiles that are launched at a same time. A magazine may include two or more projectiles that may each be launched individually at separate times. A magazine may include a single projectile configured to be launched from the magazine. Launching the projectiles may be referred to as activating (e.g., firing, deploying, launching, etc.) a magazine or projectile launcher. Prior to use, one or more projectiles may be inserted into the magazine. The magazine may then be coupled to a handle of a projectile launcher. After use (e.g., after activation), a magazine may be removed from the bay and reloaded with projectiles and/or replaced with an unused (e.g., not fired, not activated) magazine to permit additional launch of projectile(s).

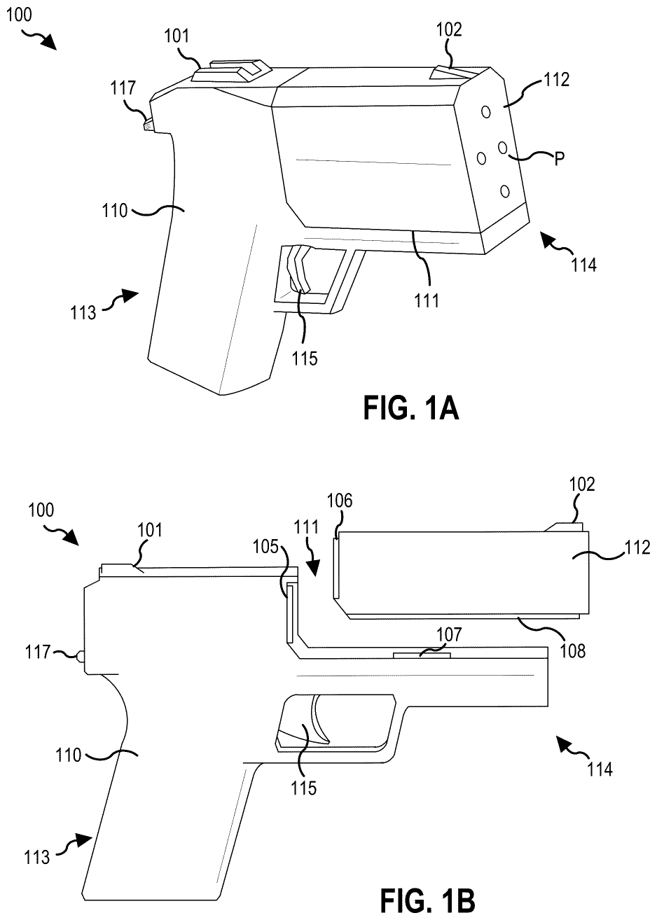

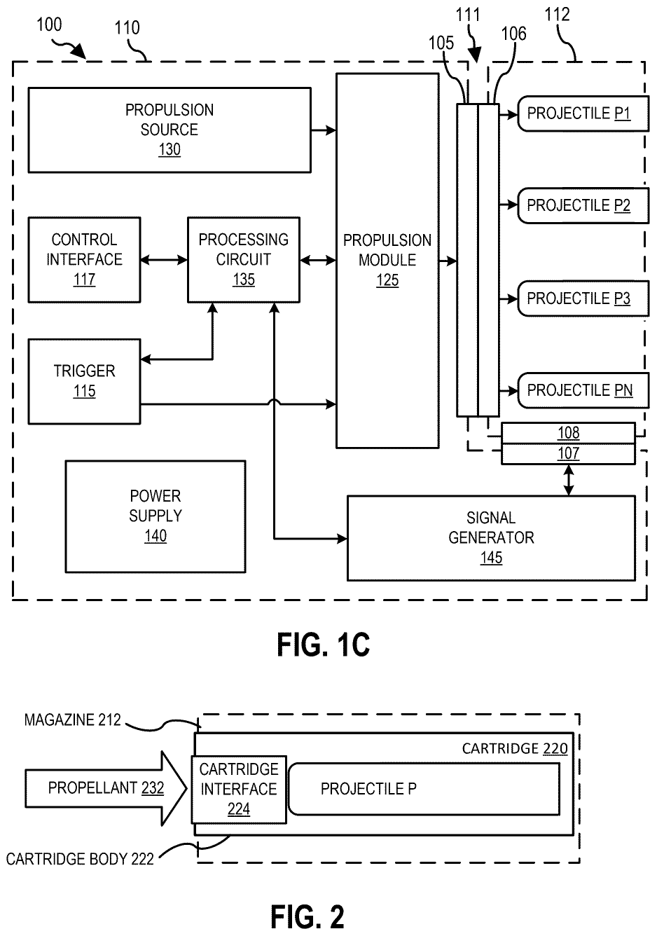

In various embodiments, and with reference to FIGS. 1A-1C, a projectile launcher 100 is disclosed. Projectile launcher 100 may be similar to, or have similar aspects and/or components with, any projectile launcher, CEW, or the like discussed herein. Projectile launcher 100 may comprise a handle 110 and a magazine 112. It should be understood by one skilled in the art that FIG. 1C is a schematic representation of projectile launcher 100, and one or more of the components of projectile launcher 100 may be located in any suitable position within, or external to, handle 110.

Handle 110 may be configured to house various components of projectile launcher 100 that are configured to enable deployment of projectiles from magazine 112, provide an electrical current to magazine 112, and otherwise aid in the operation of projectile launcher 100, as discussed further herein. Although depicted with firearm shape in FIGS. 1A and 1B, handle 110 may comprise any suitable shape and/or size. Handle 110 may comprise a handle end 113 opposite a deployment end 114. Deployment end 114 may be configured, and sized and shaped, to receive one or more magazine 112. Handle end 113 may be sized and shaped to be held in a hand of a user. For example, handle end 113 may be shaped as a handle to enable hand-operation of projectile launcher 100 by the user. In various embodiments, handle end 113 may also comprise contours shaped to fit the hand of a user, for example, an ergonomic grip. Handle end 113 may include a surface coating, such as, for example, a non-slip surface, a grip pad, a rubber texture, and/or the like. As a further example, handle end 113 may be wrapped in leather, a colored print, and/or any other suitable material, as desired.

In various embodiments, handle 110 may comprise various mechanical, electronic, and/or electrical components configured to aid in performing the functions of projectile launcher 100. For example, handle 110 may comprise one or more of each of trigger 115, control interface 117, processing circuit 135, and power supply 140, and/or signal generator 145. Handle 110 may include a guard (e.g., trigger guard). A guard may define an opening formed in handle 110. A guard may be located on a center region of handle 110 (e.g., as depicted in FIGS. 1A and 1B), and/or in any other suitable location on handle 110. Trigger 115 may be disposed within a guard. A guard may be configured to protect trigger 115 from unintentional physical contact (e.g., an unintentional activation of trigger 115). A guard may surround trigger 115 within handle 110.

In various embodiments, trigger 115 be coupled to an outer surface of handle 110, and may be configured to move, slide, rotate, or otherwise become physically depressed or moved upon application of physical contact. For example, trigger 115 may be actuated by physical contact applied to trigger 115 from within a guard. Trigger 115 may comprise a mechanical or electromechanical switch, button, trigger, or the like. For example, trigger 115 may comprise a switch, a pushbutton, and/or any other suitable type of trigger. Trigger 115 may be mechanically and/or electronically coupled to processing circuit 135. In response to trigger 115 being activated (e.g., depressed, pushed, etc. by the user), processing circuit 135 may enable deployment of (or cause deployment of) one or more magazine 112 from projectile launcher 100, as discussed further herein.

In various embodiments, power supply 140 may be configured to provide power to various components of projectile launcher 100. For example, power supply 140 may provide energy for operating the electronic and/or electrical components (e.g., parts, subsystems, circuits, etc.) of projectile launcher 100 and/or one or more magazine 112. Power supply 140 may provide electrical power. Providing electrical power may include providing a current at a voltage. Power supply 140 may be electrically coupled to processing circuit 135 and/or signal generator 145. In various embodiments, in response to a control interface comprising electronic properties and/or components, power supply 140 may be electrically coupled to the control interface. In various embodiments, in response to trigger 115 comprising electronic properties or components, power supply 140 may be electrically coupled to trigger 115. Power supply 140 may provide an electrical current at a voltage. Electrical power from power supply 140 may be provided as a direct current (“DC”). Electrical power from power supply 140 may be provided as an alternating current (“AC”). Power supply 140 may include a battery. The energy of power supply 140 may be renewable or exhaustible, and/or replaceable. For example, power supply 140 may comprise one or more rechargeable or disposable batteries. In various embodiments, the energy from power supply 140 may be converted from one form (e.g., electrical, magnetic, thermal) to another form to perform the functions of a system.

Power supply 140 may provide energy for performing the functions of projectile launcher 100. For example, power supply 140 may provide the electrical current to signal generator 145 that is provided through a target to impede locomotion of the target (e.g., via magazine 112). Power supply 140 may provide the energy for a stimulus signal. Power supply 140 may provide the energy for other signals, including an ignition signal, as discussed further herein.

In various embodiments, processing circuit 135 may comprise any circuitry, electrical components, electronic components, software, and/or the like configured to perform various operations and functions discussed herein. For example, processing circuit 135 may comprise a processing circuit, a processor, a digital signal processor, a microcontroller, a microprocessor, an application specific integrated circuit (ASIC), a programmable logic device, logic circuitry, state machines, microelectromechanical systems (MEMS) devices, signal conditioning circuitry, communication circuitry, a computer, a computer-based system, a radio, a network appliance, a data bus, an address bus, and/or any combination thereof. In various embodiments, processing circuit 135 may include passive electronic devices (e.g., resistors, capacitors, inductors, etc.) and/or active electronic devices (e.g., op amps, comparators, analog-to-digital converters, digital-to-analog converters, programmable logic, status relay controls (SRCs), transistors, etc.). In various embodiments, processing circuit 135 may include data buses, output ports, input ports, timers, memory, arithmetic units, and/or the like.

In various embodiments, processing circuit 135 may include signal conditioning circuity. Signal conditioning circuitry may include level shifters to change (e.g., increase, decrease) the magnitude of a voltage (e.g., of a signal) before receipt by processing circuit 135 or to shift the magnitude of a voltage provided by processing circuit 135.

In various embodiments, processing circuit 135 may be configured to control and/or coordinate operation of some or all aspects of projectile launcher 100. For example, processing circuit 135 may include (or be in communication with) memory configured to store data, programs, and/or instructions. The memory may comprise a tangible non-transitory computer-readable memory. Instructions stored on the tangible non-transitory memory may allow processing circuit 135 to perform various operations, functions, and/or steps, as described herein.

The term “non-transitory” as used herein is to be understood to remove only propagating transitory signals per se from the claim scope and does not relinquish rights to all standard computer-readable media that are not only propagating transitory signals per se. Stated another way, the meaning of the term “non-transitory computer-readable memory,” “non-transitory memory,” and similar phrases should be construed to exclude only those types of transitory computer-readable media which were found in In re Nuijten to fall outside the scope of patentable subject matter under 35 U.S.C. § 101.

In various embodiments, the memory may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Processing circuit 135 may be configured to provide and/or receive electrical signals whether digital and/or analog in form. Processing circuit 135 may provide and/or receive digital information via a data bus using any protocol. Processing circuit 135 may receive information, manipulate the received information, and provide the manipulated information. Processing circuit 135 may store information and retrieve stored information. Information received, stored, and/or manipulated by processing circuit 135 may be used to perform a function, control a function, and/or to perform an operation or execute a stored program.

Processing circuit 135 may control the operation and/or function of other circuits and/or components of projectile launcher 100. Processing circuit 135 may receive or determine status information regarding the operation of other components, perform calculations with respect to the status information, and provide commands (e.g., instructions) to one or more other components. Processing circuit 135 may command another component to start operation, continue operation, alter operation, suspend operation, cease operation, or the like. Commands and/or status may be communicated between processing circuit 135 and other circuits and/or components via any suitable electrical signal or electronic communication. Commands and/or status may be communicated between processing circuit 135 and other circuits and/or components via any type of bus (e.g., SPI bus) including any type of data/address bus.

In various embodiments, processing circuit 135 may comprise or be in electronic communication with a communications unit. The communications unit may be similar to, or comprise similar components with, any other communications unit, short-range communications unit, long-range communications unit, or the like disclosed here. The communications unit may enable electronic communications between devices and systems. The communications unit may enable communications over a network. For example, the communications unit may include a modem, a network interface (such as an Ethernet card), a communications port, or the like. Data may be transferred via the communications unit in the form of signals which may be electronic, electromagnetic, optical, or other signals capable of being transmitted or received by a communications unit. The communications unit may be configured to communicate via any wired protocol, wireless protocol, or other protocol capable of transmitting information via a wired or wireless connection. In various embodiments, the communications unit may be configured to enable short-range communications between devices. In various embodiments, the communications unit may be configured to enable long-range communications between devices or systems. In various embodiments, the communications unit may be configured to enable both short-range communications and long-range communications.

In various embodiments, processing circuit 135 may be mechanically and/or electronically coupled to trigger 115. In various embodiments, processing circuit 135 may be electrically coupled to a switch or other electrical component associated with or activated by trigger 115. Processing circuit 135 may be configured to detect an activation, actuation, depression, input, etc. (collectively, an “activation event”) of trigger 115. In response to detecting the activation event, processing circuit 135 may be configured to perform various operations and/or functions, as discussed further herein. Processing circuit 135 may also include a sensor (e.g., a trigger sensor) attached to or activated by trigger 115 and configured to detect or receive activation of an activation event of trigger 115. The sensor may comprise any suitable sensor, such as a mechanical and/or electronic sensor capable of detecting or receiving an activation event in trigger 115 and reporting the activation event to processing circuit 135.

In various embodiments, processing circuit 135 may be mechanically and/or electronically coupled to control interface 117. In various embodiments, processing circuit 135 may be electrically coupled to a switch or other electrical component associated with or activated by control interface 117. Processing circuit 135 may be configured to detect or receive an activation, actuation, depression, input, signal, communication, etc. (collectively, a “control event”) of control interface 117. In response to detecting or receiving the control event, processing circuit 135 may be configured to perform various operations and/or functions, as discussed further herein. Processing circuit 135 may also include a sensor (e.g., a control sensor) attached to or activated by control interface 117 and configured to detect or receive activation of a control event of control interface 117. The sensor may comprise any suitable sensor, such as a mechanical and/or electronic sensor capable of detecting or receiving a control event in control interface 117 and reporting the control event to processing circuit 135.

In various embodiments, processing circuit 135 may be electrically and/or electronically coupled to power supply 140. Processing circuit 135 may receive power from power supply 140. The power received from power supply 140 may be used by processing circuit 135 to receive signals, process signals, and transmit signals to various other components in projectile launcher 100. Processing circuit 135 may use power from power supply 140 to detect or receive an activation event of trigger 115, a control event of control interface 117, or the like, and generate one or more control signals in response to the detected events. The control signal may be based on the control event and the activation event. The control signal may be an electrical signal.

Processing circuit 135 may control provision of power from power supply 140 to one or more other components of projectile launcher 100. For example, power may be provided to one or more other components via an electrical circuit of projectile launcher 100. The electrical circuit may comprise any suitable type of electrical circuit and may include one or more passive components and/or active components. In some embodiments, the electrical circuit may comprise one or more electrical switches configured to control provision of power to components of projectile launcher 100. Processing circuit 135 may be electrically coupled to the one or more electrical switches. Processing circuit 135 may be configured to control the electrical switches via electrical signals to close or open the electrical switches.

In various embodiments, processing circuit 135 may be electrically and/or electronically coupled to signal generator 145. Processing circuit 135 may be configured to transmit or provide control signals to signal generator 145 in response to detecting an activation event of trigger 115. Multiple control signals may be provided from processing circuit 135 to signal generator 145 in series. In response to receiving the control signal, signal generator 145 may be configured to perform various functions and/or operations, as discussed further herein. In some embodiments, control signals from processing circuit 135 to signal generator 145 may include signals from processing circuit 135 to provide power to or remove power from signal generator 145 (e.g., electrical signals to control electrical switches between power supply 140 and signal generator 145).

In various embodiments, signal generator 145 may be configured to receive one or more control signals from processing circuit 135. Signal generator 145 may provide an ignition signal to magazine 112 based on the control signals. Signal generator 145 may be electrically and/or electronically coupled to processing circuit 135 and/or magazine 112. Signal generator 145 may be electrically coupled to power supply 140. Signal generator 145 may use power received from power supply 140 to generate an ignition signal. For example, signal generator 145 may receive an electrical signal from power supply 140 that has first current and voltage values. Signal generator 145 may transform the electrical signal into an ignition signal having second current and voltage values. The transformed second current and/or the transformed second voltage values may be different from the first current and/or voltage values. The transformed second current and/or the transformed second voltage values may be the same as the first current and/or voltage values. Signal generator 145 may temporarily store power from power supply 140 and rely on the stored power entirely or in part to provide the ignition signal. Signal generator 145 may also rely on received power from power supply 140 entirely or in part to provide the ignition signal, without needing to temporarily store power.

Signal generator 145 may be controlled entirely or in part by processing circuit 135. In various embodiments, signal generator 145 and processing circuit 135 may be separate components (e.g., physically distinct and/or logically discrete). Signal generator 145 and processing circuit 135 may be a single component. For example, a control circuit within handle 110 may at least include signal generator 145 and processing circuit 135. The control circuit may also include other components and/or arrangements, including those that further integrate corresponding function of these elements into a single component or circuit, as well as those that further separate certain functions into separate components or circuits.

Signal generator 145 may be controlled by the control signals to generate an ignition signal having a predetermined current value or values. For example, signal generator 145 may include a current source. The control signal may be received by signal generator 145 to activate the current source at a current value of the current source. An additional control signal may be received to decrease a current of the current source. For example, signal generator 145 may include a pulse width modification circuit coupled between a current source and an output of the control circuit. A second control signal may be received by signal generator 145 to activate the pulse width modification circuit, thereby decreasing a non-zero period of a signal generated by the current source and an overall current of an ignition signal subsequently output by the control circuit. The pulse width modification circuit may be separate from a circuit of the current source or, alternatively, integrated within a circuit of the current source. Various other forms of signal generators 45 may alternatively or additionally be employed, including those that apply a voltage over one or more different resistances to generate signals with different currents. In various embodiments, signal generator 145 may include a high-voltage module configured to deliver an electrical current having a high voltage. In various embodiments, signal generator 145 may include a low-voltage module configured to deliver an electrical current having a lower voltage, such as, for example, 2,000 volts.

Responsive to receipt of a signal indicating activation of trigger 115 (e.g., an activation event), a control circuit provides an ignition signal to magazine 112 (or one or more projectiles P in magazine 112). For example, signal generator 145 may provide an electrical signal as an ignition signal to magazine 112 in response to receiving a control signal from processing circuit 135. In various embodiments, the ignition signal may be separate and distinct from a stimulus signal. For example, a stimulus signal in projectile launcher 100 may be provided to a different circuit within magazine 112, relative to a circuit to which an ignition signal is provided. Signal generator 145 may be configured to generate a stimulus signal. In various embodiments, a second, separate signal generator, component, or circuit (not shown) within handle 110 may be configured to generate the stimulus signal. Signal generator 145 may also provide a ground signal path for magazine 112, thereby completing a circuit for an electrical signal provided to magazine 112 by signal generator 145. The ground signal path may also be provided to magazine 112 by other elements in handle 110, including power supply 140.

In various embodiments, a bay 111 of handle 110 may be configured (to receive one or more magazine 112. Bay 111 may comprise an opening in deployment end 114 sized and shaped to receive one or more magazine 112. Bay 111 may include one or more mechanical features configured to removably couple one or more magazine 112 within bay 111. Bay 111 may be configured to receive a single magazine, two magazines, three magazines, nine magazines, or any other number of magazines.

In various embodiments, magazine 112 may comprise a housing sized and shaped to be inserted into bay 111. The housing may define one or more bores. Each bore may define an opening through the housing (e.g., a chamber). Each bore may be configured to receive a projectile. Each bore may be sized and shaped accordingly to receive and house a projectile prior to and during deployment of the projectile from magazine 112. Each bore may comprise any suitable deployment angle. One or more bores may comprise similar deployment angles. One or more bores may comprise different deployment angles. The housing may comprise any suitable or desired number of bores, such as, for example, two bores, five bores, eight bores (e.g., as depicted), ten bores, and/or the like.

In various embodiments, magazine 112 may be configured to receive one or more projectiles P, such as, for example, a first projectile P0, a second projectile P1, a third projectile P2, an Nth projectile PN, and/or the like. Magazine 112 may be configured to receive a number of projectile P equal to or less than a number of bores in magazine 112. Each projectile P may comprise a body and one or more components necessary to store and/or deploy the projectile P from the body. Each projectile P may be similar to any other electrode, projectile, or the like disclosed herein. As referred to herein, projectiles P0, P1, P2, PN may be generally referred to individually as a “projectile P” or in a plurality as “projectiles P.”

In various embodiments, handle 110 may comprise a propulsion module 125. Propulsion module 125 may be configured to provide a propulsion force to deploy, or cause deployment of, one or more projectiles P. Propulsion module 125 may comprise any device, propellant, primer, or the like capable of providing a propulsion force. The propulsion force may include an increase in pressure caused by rapidly expanding gas within an area or chamber.

Propulsion module 125 may be configured to receive a propellant from a propulsion source 130. In that regard, propulsion module 125 may be in fluid communication with propulsion source 130. Propulsion source 130 may comprise a volume of propellant configured to provide, directly or indirectly, the propulsion force. Propulsion source 130 may contain an amount of propellant under a storage pressure. The propellant may comprise any suitable propellant fluid, gas, or the like capable of deploying, or causing deployment of, a projectile P. For example, the propellant may comprise a compressed air, carbon dioxide gas (e.g., CO2), a nitrous oxide gas (e.g., N2O), nitrogen gas, and/or the like. Propulsion source 130 may comprise a compressed air cannister, a carbon dioxide cannister (e.g., CO2 cannister), a nitrous oxide cannister (e.g., N2O canister), a nitrogen cannister, and/or the like. In some embodiments, propulsion source 130 and/or propulsion module 125 may comprise one or more accessory systems, such as, for example, a pressure regulating system, a cannister ejection system, a pressure monitoring system, and/or the like.

Propulsion module 125 may be configured to receive an amount of propellant from propulsion source 130. For example, propulsion module 125 may receive the amount of propellant based on operation of trigger 115, control interface 117, processing circuit 135, and/or through any other suitable operation or control. As a further example, propulsion module 125 may receive the amount of propellant in response to an ignition signal, a control signal, and/or any other suitable electrical signal. The amount of propellant may comprise any volume, flow, or the like of propellant capable of deploying, or causing deployment of, one or more projectiles P.

In various embodiments, propulsion module 125 may be in electrical and/or electronic communication with processing circuit 135. In that regard, and in some embodiments, processing circuit 135 may control operations of propulsion module 125. For example, controlling operations may include causing propulsion module 125 to receive propellant from propulsion source 130, instructing propulsion module 125 to deliver a propulsion force to one or more projectiles P, selecting one or more projectiles P for propulsion module 125 to deliver the propulsion force to, and/or the like.

In various embodiments, propulsion module 125 may be in electrical and/or mechanical communication with trigger 115. In that regard, in some embodiments trigger 115 may control operations of propulsion module 125. For example, controlling operations may include causing propulsion module 125 to receive propellant from propulsion source 130, causing propulsion module 125 to deliver a propulsion force to one or more projectiles P, selecting one or more projectiles P for propulsion module 125 to deliver the propulsion force to, and/or the like.

In various embodiments, propulsion module 125 may be in fluid communication with magazine 112 and/or one or more projectiles P. Propulsion module 125 may be configured to provide the propulsion force to magazine 112 and/or one or more projectiles P. Receiving the propulsion force may cause one or more projectiles P to be deployed from magazine 112.

In various embodiments, the propulsion force may be directly applied to one or more projectiles P. For example, a propulsion force from propulsion module 125 may be provided directly to first projectile P1 to cause deployment of first projectile P1. Propulsion module 125 may be in fluid communication with one or more projectiles P to provide the propulsion force. For example, a propulsion force from propulsion module 125 may travel within a housing or channel of magazine 112 to first projectile P1. The propulsion force may travel via a manifold in magazine 112.

In various embodiments, the propulsion force may be provided indirectly to one or more projectiles P. For example, the propulsion force may be provided to a secondary source of propellant within propulsion module 125. The propulsion force may launch the secondary source of propellant within propulsion module 125, causing the secondary source of propellant to release propellant. A force associated with the released secondary source of propellant may in turn provide a propulsion force to one or more projectiles P. A force generated by a secondary source of propellant may cause the one or more projectiles P to be deployed from magazine 112.

In various embodiments, handle 110 and/or magazine 112 may comprise one or more interfaces. For example, handle 110 and/or magazine 112 may comprise a mechanical interface. A mechanical interface may be configured to enable magazine 112 to mechanically couple to handle 110. A mechanical interface may also be configured to at least partially seal (e.g., fluidly seal, hermetically seal, etc.) the mechanical coupling between magazine 112 and handle 110. As a further example, handle 110 and/or magazine 112 may comprise an electrical interface. An electrical interface may be configured to enable electrical signals to be provided from handle 110 to magazine 112 and/or from magazine 112 to handle 110. As a further example, handle 110 and/or magazine 112 may comprise an electronic interface. An electronic interface may be configured to enable electronic communication between handle 110 and magazine 112 (e.g., one-way communication, two-way communication, transmission of data packets, etc.). As a further example, handle 110 and/or magazine 112 may comprise a fluid interface. A fluid interface may enable handle 110 to provide a fluid (e.g., propulsion force, propellant, etc.) to magazine 112.

In various embodiments, a mechanical interface may comprise an interposer. An interposer may be configured to couple to an end of magazine 112 and at least partially seal the end of the magazine 112. The interposer may be configured to at least partially retain or couple to one or more projectiles loaded into magazine 112. The interposer may be configured to at least partially prevent electrical shorting between two or more projectiles loaded into magazine 112. The interposer may be configured to provide electrical coupling between signal generator 145 and the one or more projectiles in magazine 112 (e.g., to provide ignition signals, stimulus signals, etc.). The interposer may be configured to at least partially reduce a recoil force imparted into handle 110 in response to deployment of one or more projectiles from magazine 112. In that regard, the interposer may comprise one or more surfaces or materials configured to receive and distribute an impact load from a projectile deployment. In some embodiments, at least partially reducing the recoil force imparted from deployment of a projectile may increase the lifespan of one or more components in a projectile, magazine 112, and/or handle 110.

For example, and in accordance with various embodiments, handle 110 may comprise a first handle interface 105 and magazine 112 may comprise a first magazine interface 106. First handle interface 105 may be disposed within bay 111. First handle interface 105 may be coupled to, extend through, or be defined on an inner surface of bay 111. For example, first handle interface 105 may be coupled to, extend through, or be defined on a rear inner surface of bay 111. First magazine interface 106 may be coupled to, extend through, or be defined on an outer surface of magazine 112. For example, first magazine interface 106 may be coupled to, extend through, or be defined on a rear outer surface of magazine 112. First handle interface 105 and first magazine interface 106 may at least partially align in response to magazine 112 coupling to handle 110.

In various embodiments, first handle interface 105 and first magazine interface 106 may each comprise any number of interfaces. For example, first handle interface 105 may comprise one or more interfaces and first magazine interface 106 may comprise one or more interfaces. In that regard, first handle interface 105 may comprise one or more of a mechanical interface, an electrical interface, an electronic interface, and/or a fluid interface. First magazine interface 106 may comprise one or more of a mechanical interface, an electrical interface, an electronic interface, and/or a fluid interface. In some embodiments, first handle interface 105 and first magazine interface 106 may each comprise a same number of interfaces. In some embodiments, first handle interface 105 and first magazine interface 106 may each comprise a different number of interfaces.

In various embodiments, first handle interface 105 and first magazine interface 106 may comprise complimentary interfaces. For example, first handle interface 105 and first magazine interface 106 may each comprise a mechanical interface. The mechanical interface of first handle interface 105 may engage with the mechanical interface of first magazine interface 106 to mechanically couple magazine 112 to handle 110. The mechanical interfaces may be complimentary. For example, the mechanical interface of first handle interface 105 may comprise a female interface and the mechanical interface of first magazine interface 106 may comprise a male interface configured to engage with the female interface.

As a further example, first handle interface 105 and first magazine interface 106 may each comprise an electrical interface. The electrical interface of first handle interface 105 may engage with the electrical interface of first magazine interface 106 to electrically couple magazine 112 to handle 110. The electrical interfaces may be complimentary. For example, the electrical interface of first handle interface 105 may comprise an electrical contact and the electrical interface of first magazine interface 106 may comprise an electrical contact. The electrical contacts may be at least partially aligned and in contact to electrically couple magazine 112 to handle 110.

As a further example, first handle interface 105 and first magazine interface 106 may each comprise an electronic interface. The electronic interface of first handle interface 105 may engage with the electronic interface of first magazine interface 106 to electronically couple magazine 112 to handle 110. For example, the electronic interface of first handle interface 105 may comprise a communications unit and the electronic interface of first magazine interface 106 may comprise a communications unit. The communication units may communicate via a wired or wireless connection to electronically couple magazine 112 to handle 110. As a further example, the electronic interfaces may communicate via a physical connection, such as via electrical contacts, data ports, and/or the like.

As a further example, first handle interface 105 and first magazine interface 106 may each comprise a fluid interface. The fluid interface of first handle interface 105 may engage with the fluid interface of first magazine interface 106 to fluidly couple magazine 112 to handle 110. For example, the fluid interface of first handle interface 105 may comprise a distribution module (e.g., a fluid distribution module) configured to distribute a fluid (e.g., propulsion force) provided by propulsion module 125. The fluid interface of first magazine interface 106 may comprise a port or opening (e.g., a fluid channel, a bore in magazine 112, etc.) configured to enable the fluid to be distributed from the fluid interface of first handle interface 105 to one or more projectiles P of magazine 112.

In various embodiments, first handle interface 105 and first magazine interface 106 may each comprise a fluid interface. In various embodiments, first handle interface 105 and first magazine interface 106 may each comprise a mechanical interface and a fluid interface.

In various embodiments, handle 110 may comprise a second handle interface 107 and magazine 112 may comprise a second magazine interface 108. Second handle interface 107 may be disposed within bay 111. Second handle interface 107 may be coupled to, extend through, or be defined on an inner surface of bay 111. For example, second handle interface 107 may be coupled to, extend through, or be defined on a bottom inner surface of bay 111. Second magazine interface 108 may be coupled to, extend through, or be defined on an outer surface of magazine 112. For example, second magazine interface 108 may be coupled to, extend through, or be defined on a bottom outer surface of magazine 112. Second handle interface 107 and second magazine interface 108 may at least partially align in response to magazine 112 coupling to handle 110.

In various embodiments, second handle interface 107 and second magazine interface 108 may each comprise any number of interfaces. For example, second handle interface 107 may comprise one or more interfaces and second magazine interface 108 may comprise one or more interfaces. In that regard, second handle interface 107 may comprise one or more of a mechanical interface, an electrical interface, an electronic interface, and/or a fluid interface. Second magazine interface 108 may comprise one or more of a mechanical interface, an electrical interface, an electronic interface, and/or a fluid interface. In some embodiments, second handle interface 107 and second magazine interface 108 may each comprise a same number of interfaces. In some embodiments, second handle interface 107 and second magazine interface 108 may each comprise a different number of interfaces.

In various embodiments, second handle interface 107 and second magazine interface 108 may comprise complimentary interfaces. For example, second handle interface 107 and second magazine interface 108 may each comprise a mechanical interface. The mechanical interface of second handle interface 107 may engage with the mechanical interface of second magazine interface 108 to mechanically couple magazine 112 to handle 110. The mechanical interfaces may be complimentary. For example, the mechanical interface of second handle interface 107 may comprise a female interface and the mechanical interface of second magazine interface 108 may comprise a male interface configured to engage with the female interface. As a further example, the mechanical interface of second handle interface 107 may comprise a locking mechanism and the mechanical interface of second magazine interface 108 may comprise a complimentary opening configured to receive the locking mechanism. The locking mechanism may create mechanical interference to mechanical couple and position magazine 112 within bay 111 of handle 110.

As a further example, second handle interface 107 and second magazine interface 108 may each comprise an electrical interface. The electrical interface of second handle interface 107 may engage with the electrical interface of second magazine interface 108 to electrically couple magazine 112 to handle 110. The electrical interfaces may be complimentary. For example, the electrical interface of second handle interface 107 may comprise an electrical contact and the electrical interface of second magazine interface 108 may comprise an electrical contact. The electrical contacts may be at least partially aligned and in contact to electrically couple magazine 112 to handle 110.

As a further example, second handle interface 107 and second magazine interface 108 may each comprise an electronic interface. The electronic interface of second handle interface 107 may engage with the electronic interface of second magazine interface 108 to electronically couple magazine 112 to handle 110. For example, the electronic interface of second handle interface 107 may comprise a communications unit and the electronic interface of second magazine interface 108 may comprise a communications unit. The communication units may communicate via a wired or wireless connection to electronically couple magazine 112 to handle 110. As a further example, the electronic interfaces may communicate via a physical connection, such as via electrical contacts, data ports, and/or the like.

As a further example, second handle interface 107 and second magazine interface 108 may each comprise a fluid interface. The fluid interface of second handle interface 107 may engage with the fluid interface of second magazine interface 108 to fluidly couple magazine 112 to handle 110. For example, the fluid interface of second handle interface 107 may comprise a distribution module (e.g., a fluid distribution module) configured to distribute a fluid (e.g., propulsion force) provided by propulsion module 125. The fluid interface of second magazine interface 108 may comprise a port or opening (e.g., a fluid channel, a bore in magazine 112, etc.) configured to enable the fluid to be distributed from the fluid interface of second handle interface 107 to one or more projectiles P of magazine 112.

In various embodiments, second handle interface 107 and second magazine interface 108 may each comprise an electrical interface. In various embodiments, second handle interface 107 and second magazine interface 108 may each comprise a mechanical interface and an electrical interface.

In various embodiments, first handle interface 105 and first magazine interface 106 (collectively, the first interfaces) and second handle interface 107 and second magazine interface 108 (collectively, the second interfaces) may each provide at least one same or similar type of interface. For example, the first interfaces may provide at least one mechanical interface and the second interfaces may provide at least one mechanical interface. The mechanical interfaces of the first interfaces and the second interfaces may be the same or similar, or may be different. For example, the mechanical interfaces may each be mechanical alignment interfaces. As a further example, the mechanical interface of the first interfaces may comprise a mechanical sealing interface and the mechanical interface of the second interfaces may comprise a mechanical alignment interface, a mechanical locking interface, or the like.

In various embodiments, first handle interface 105 and first magazine interface 106 (collectively, the first interfaces) and second handle interface 107 and second magazine interface 108 (collectively, the second interfaces) may each provide at least one different type of interface. For example, the first interfaces may provide a fluid interface and the second interfaces may provide an electrical interface.

In various embodiments, projectile launcher 100 may deliver a stimulus signal via a circuit that includes signal generator 145 positioned in handle 110. An interface (e.g., cartridge interface, magazine interface, etc.) on each magazine 112 inserted into handle 110 electrically couples to an interface (e.g., handle interface, housing interface, etc.) in handle 110. For example, signal generator 145 may be in electrical series with second handle interface 107. Second magazine interface 108 may be electrically coupled to second handle interface 107. In that regard, signal generator 145 may be in electrical series with magazine 112 via second handle interface 107 and second magazine interface 108. Second magazine interface 108 may be in electrical series with one or more projectiles P housing in magazine 112. In that regard, a stimulus signal provided by signal generator 145 may be provided to one or more projectiles P via second handle interface 107 and second magazine interface 108. For example, a first filament wire of first projectile P1 may be electrically coupled to a first electrical interface (e.g., a positive interface) of second magazine interface 108. A second filament wire of second projectile P2 may be electrically coupled to a second electrical interface (e.g., a negative interface, a ground interface, etc.) of second magazine interface 108. The stimulus signal travels from signal generator 145, through the first electrical interface of second magazine interface 108, the first filament, first projectile P1, and tissue of a target, and returns through second projectile P2, the second filament, the second electrical interface of second magazine interface 108, and back to signal generator 145.

In various embodiments, control interface 117 may comprise, or be similar to, any control interface disclosed herein. Control interface 117 may be configured to control selection of firing modes in projectile launcher 100. Controlling selection of firing modes in projectile launcher 100 may include disabling deployment from projectile launcher 100 (e.g., a safety mode, etc.), enabling deployment from projectile launcher 100 (e.g., an active mode, a firing mode, an escalation mode, etc.), controlling deployment of magazine 112, and/or similar operations, as discussed further herein. In various embodiments, control interface 117 may also be configured to perform (or cause performance of) one or more operations that do not include the selection of firing modes. For example, control interface 117 may be configured to enable the selection of operating modes of projectile launcher 100, selection of options within an operating mode of projectile launcher 100, or similar selection or scrolling operations, as discussed further herein.

Control interface 117 may be located in any suitable location on or in handle 110. For example, control interface 117 may be coupled to an outer surface of handle 110. Control interface 117 may be coupled to an outer surface of handle 110 proximate trigger 115 and/or a guard of handle 110. Control interface 117 may be electrically, mechanically, and/or electronically coupled to processing circuit 135. In various embodiments, in response to control interface 117 comprising electronic properties or components, control interface 117 may be electrically coupled to power supply 140. Control interface 117 may receive power (e.g., electrical current) from power supply 140 to power the electronic properties or components.

Control interface 117 may be electronically or mechanically coupled to trigger 115. For example, and as discussed further herein, control interface 117 may function as a safety mechanism. In response to control interface 117 being set to a “safety mode,” projectile launcher 100 may be unable to launch projectiles P from magazine 112. For example, control interface 117 may provide a signal (e.g., a control signal) to processing circuit 135 instructing processing circuit 135 to disable deployment of projectiles P from magazine 112. As a further example, control interface 117 may electronically or mechanically prohibit trigger 115 from activating (e.g., prevent or disable a user from depressing trigger 115; prevent trigger 115 from launching a projectile P; etc.).

Control interface 117 may comprise any suitable electronic or mechanical component capable of enabling selection of firing modes. For example, control interface 117 may comprise a fire mode selector switch, a safety switch, a safety catch, a rotating switch, a selection switch, a selective firing mechanism, and/or any other suitable mechanical control. As a further example, control interface 117 may comprise a slide, such as a handgun slide, a reciprocating slide, or the like. As a further example, control interface 117 may comprise a touch screen, user interface or display, or similar electronic visual component.

The safety mode may be configured to prohibit deployment of a projectile P from magazine 112 in projectile launcher 100. For example, in response to a user selecting the safety mode, control interface 117 may transmit a safety mode instruction to processing circuit 135. In response to receiving the safety mode instruction, processing circuit 135 may prohibit deployment of a projectile P from magazine 112. Processing circuit 135 may prohibit deployment until a further instruction is received from control interface 117 (e.g., a firing mode instruction). As previously discussed, control interface 117 may also, or alternatively, interact with trigger 115 to prevent activation of trigger 115. In various embodiments, the safety mode may also be configured to prohibit provision of a stimulus signal from signal generator 145.

The firing mode may be configured to enable deployment of one or more projectiles P from magazine 112. For example, and in accordance with various embodiments, in response to a user selecting the firing mode, control interface 117 may transmit a firing mode instruction to processing circuit 135. In response to receiving (or determining) the firing mode instruction, processing circuit 135 may enable deployment of one or more projectiles P from magazine 112. In that regard, in response to trigger 115 being activated, processing circuit 135 may cause the deployment of one or more projectiles P. Processing circuit 135 may enable deployment until a further instruction is received (or determined) from control interface 117 (e.g., a safety mode instruction). As a further example, and in accordance with various embodiments, in response to a user selecting the firing mode, control interface 117 may also mechanically (or electronically) interact with trigger 115 to enable activation of trigger 115.

In various embodiments, projectile launcher 100 may further comprise one or more user interfaces. A user interface may be configured to receive an input from a user of projectile launcher 100 and/or transmit or provide an output to the user of projectile launcher 100. The user interface may be part of control interface 117. The user interface may be a distinct component of projectile launcher 100 separate from control interface 117. The user interface may be located in any suitable location on or in handle 110. For example, the user interface may be coupled to an outer surface of handle 110, or extend at least partially through the outer surface of handle 110. The user interface may be electrically, mechanically, and/or electronically coupled to processing circuit 135. In various embodiments, in response to the user interface comprising electronic or electrical properties or components, the user interface may be electrically coupled to power supply 140. The user interface may receive power (e.g., electrical current) from power supply 140 to power the electronic properties or components.

In various embodiments, the user interface may comprise one or more components configured to receive an input from a user. For example, the user interface may comprise one or more of an audio capturing module (e.g., microphone) configured to receive an audio input, a visual display (e.g., touchscreen, LCD, LED, etc.) configured to receive a manual input, a mechanical interface (e.g., button, switch, etc.) configured to receive a manual input, and/or the like. In various embodiments, the user interface may comprise one or more components configured to transmit, provide, and/or produce an output. For example, the user interface may comprise one or more of an audio output module (e.g., audio speaker) configured to output audio, a light-emitting component (e.g., flashlight, laser guide, LED, etc.) configured to output light, a visual display (e.g., touchscreen, LCD, LED, etc.) configured to output a visual, and/or the like.

In various embodiments, projectile launcher 100 may comprise an aiming apparatus. The aiming apparatus may be coupled to a top surface of projectile launcher 100 (e.g., a top surface of handle 110 and/or a top surface of magazine 112). The aiming apparatus may comprise a telescopic sight (e.g., a scope, an optical sighting device, etc.), a red-dot sight, a holographic sight, a night vision sight, a fiber-optic sight, and/or any other suitable or desired system or apparatus to aid in aiming projectile launcher 100. The aiming apparatus may also comprise a pair of sights, including a front sight and a rear sight. In operation, a user may visually align the front sight with the rear sight to aim at a target and/or ensure projectiles P are accurately deployed.

In various embodiments, handle 110 and magazine 112 may each comprise a separate aiming apparatus. For example, handle 110 may comprise a first aiming apparatus 101 (e.g., a handle aiming apparatus, a rear sight, etc.) and magazine 112 may comprise a second aiming apparatus 102 (e.g., a magazine aiming apparatus, a front sight, etc.). First aiming apparatus 101 may be coupled to a top surface of handle 110 rearward of bay 111. Second aiming apparatus 102 may be coupled to a top surface of magazine 112. First aiming apparatus 101 and second aiming apparatus 102 may be aligned (e.g., in response to magazine 112 being coupled to handle 110). For example, first aiming apparatus 101 and second aiming apparatus 102 may be coplanar and/or colinear. First aiming apparatus 101 may be configured to visually align with second aiming apparatus 102. For example, first aiming apparatus 101 may comprise a rear sight and second aiming apparatus 102 may comprise a front sight. The rear sight may define a “U” shaped void, a “V” shaped void, or a similar rectangular shaped void. The front sight may comprise a shape complimentary to the void of the rear sight. In operation, a user may visually align the front sight within the void of the rear sight to aim projectile launcher 100 and/or to ensure projectiles P are accurately deployed.

In various embodiments, a cartridge for a projectile launcher is provided. The cartridge may comprise an undeployed projectile. The cartridge may be activated by the projectile launcher. Responsive to being activated, the projectile may be deployed from the cartridge. For example, and with brief reference to FIG. 2, cartridge 220 is disclosed. Cartridge 220 may comprise cartridge body 222, cartridge interface 224, and projectile P. Projectile P may perform one or more operations of one more other projectiles disclosed herein. For example, projectile P may correspond to at least one of first projectile P1, second projectile P2, third projectile P3, and/or Nth projectile PN with brief reference to FIG. 1C.

In embodiments, a cartridge may comprise a cartridge body. The cartridge body may comprise a hollow interior in which one or more elements of the cartridge are received. The cartridge body may comprise a rigid material. The cartridge body may extend from a first end to a second end. The first end may comprise an opening through which a projectile may be launched. The second end may comprise a cartridge interface through which one or more signals and/or physical forces may be received by the cartridge. For example, cartridge 220 may comprise cartridge body 222. Cartridge body 222 may comprise a hollow interior in which projectile P is disposed prior to launch of projectile P from cartridge 220. Cartridge body 222 may comprise a first end through which projectile P may pass after a propulsion force is applied to projectile P. Cartridge body 222 may further comprise a second end at which cartridge interface 224 is disposed. In embodiments, cartridge body 222 may receive projectile P via the first end. In embodiments, projectile P may be retained in cartridge body 222 by cartridge interface 224. Cartridge interface 224 may prevent projectile P from being received in a hollow interior of cartridge body 222 via the second at which cartridge interface 224 is disposed.

In embodiments, a cartridge may comprise a cartridge interface. The cartridge interface may be configured to couple one or more signals and/or physical forces to a projectile. The cartridge interface may be configured to at least partially retain a projectile within a cartridge housing of the cartridge. For example, cartridge 220 may comprise cartridge interface 224. Cartridge interface 224 may comprise a passage through which a propulsion force may be received. Via the passage, the propulsion force may be coupled to projectile P. For example, cartridge interface 224 may comprise a fluid passage through which propellant 232 may be received and further fluidly coupled to a surface of projectile P. Cartridge interface 224 may enable a propulsion force provided by propellant 232 to be directed to at least one surface of projectile P in order to cause projectile P to be deployed from cartridge 220 in response to the propulsion force. In embodiments, propellant 232 may be received by cartridge interface 224 from a handle interface or combination of a handle interface and magazine interface. For example, propellant 232 may be coupled to cartridge interface 224 via first handle interface 105 or a combination of first handle interface 105 and first magazine interface 106 according to various aspects of the present disclosure.

In embodiments, a cartridge may be received in a magazine. For example, cartridge 220 may be received in magazine 212 with brief reference to FIG. 2. Magazine 212 may perform one or more operations of magazine 112 with brief reference to FIG. 1A-1C. Magazine 212 may comprise a housing. The housing may comprise a recess in which cartridge 220 may be received. For example, magazine 212 may comprise a firing tube configured to receive cartridge 220. Cartridge interface 224 may be disposed at a first end of the firing tube of magazine 212. The firing tube of magazine 212 may align cartridge 220 with cartridge interface 224. A second end of the firing tube may comprise an opening through which projectile P may be deployed upon activation of cartridge 220. In other embodiments according to various aspects of the present disclosure, projectile P may be directly received in one more of magazine 212 without a separate cartridge body and/or directly received in a bay of a handle of a projectile launcher.

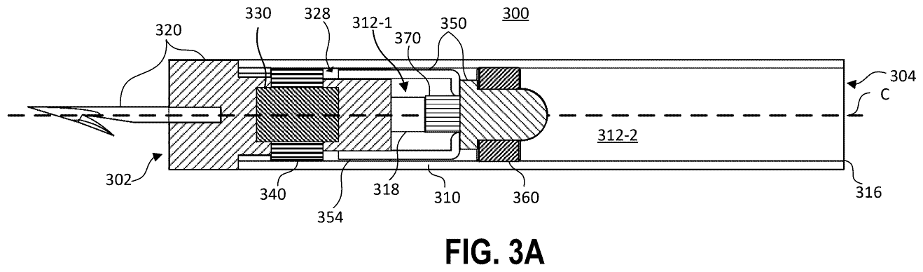

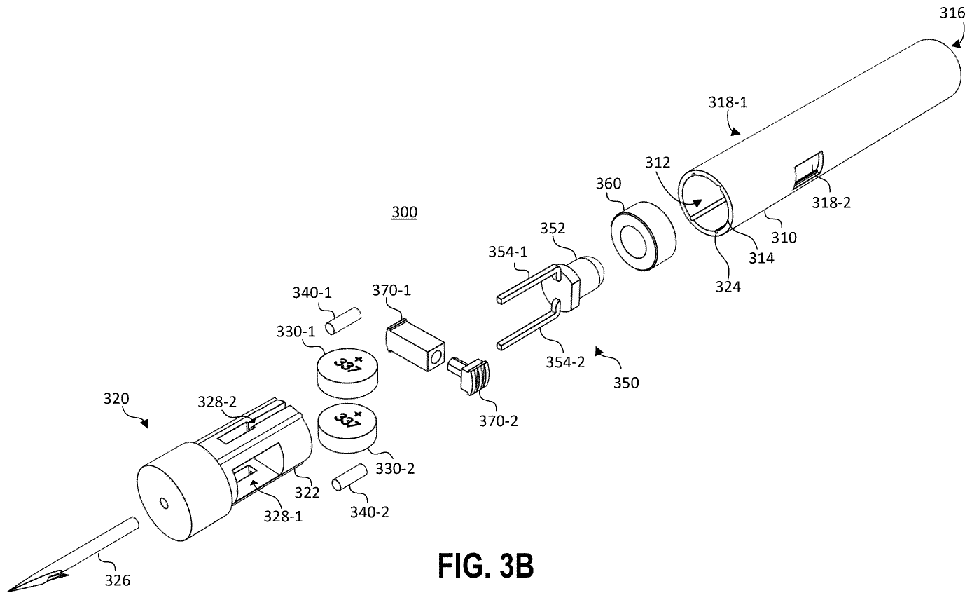

In embodiments according to various aspects of the present disclosure, a projectile is provided. The projectile may comprise a lighted projectile. The lighted projectile may include a light source. The light source may be selectively activated. Based on selective activation of the light source, energy stored in a power supply of the projectile that provides power to the light source may be preserved. In embodiments, the selective activation of the light source may enable the energy to be preserved for use across multiple deployments of the lighted projectile. In embodiments, the selective activation may enable automatic control of when the lighted projectile transitions from a deactivated state to an activated state. For example, and according to various embodiments, the selective activation may enable automatic activation of a light source of the lighted projectile upon deployment of the lighted projectile. In embodiments, the selective activation may also enable manual control of when the lighted projectile transitions from an activation state in which light is emitted from the light source to a deactivated state in which the light is not emitted from the light source. Such manual control may enable a duration over which a light source is activated, thereby improving visibility of the projectile, to be controlled by a user after the projectile has been deployed. In embodiments, the lighted projectile may enable manners of manual and/or automatic control of the selective activation of the light source. For example, and with brief reference to FIG. 3A-3B, projectile 300 may comprise a lighted projectile. In embodiments, projectile 300 may comprise one or more of housing 310, projectile head 320, at least one power supply 330, at least one light source 350, and/or at least one switch. The at least one switch may selectively couple at least one light source 350 to at least one power supply 330, thereby enabling selective activation of at least one light source 350. In embodiments, the at least one switch may comprise one or more contacts 340, at least a portion of at least one light source 350, at least one movable weight 360, and/or at least one user interface 370. Projectile 300 may perform function(s) of one or more other projectiles disclosed herein. For example, and with brief reference to FIG. 1-2, first projectile P1, second projectile P2, third projectile P3, nth projectile PN, and/or projectile P may comprise projectile 300 according to various aspects of the present disclosure.

In embodiments, a projectile may comprise a first end configured to contact a target, as well as second end configured to receive a propulsion force to propel the projectile toward a target. For example, projectile 300 may comprise first end 302 and second end 304. First end 302 may be disposed opposite second end 304. A longest dimension of projectile 300 may be disposed between first end 302 and second end 304. Projectile 300 may comprise an elongated shape between first end 302 and second end 304. A central axis C of projectile 300 may be disposed between first end 302 and second end 304.

In embodiments, first end 302 may comprise a contact end of projectile 300. First end 302 may be oriented toward a target location upon deployment of projectile 300 toward the target location. First end 302 may remain oriented toward the target location while projectile 300 is in flight toward the target location. First end 302 may be configured to contact a target at the target location. One or more features of projectile 300 may be disposed at first end 302 in order to at least temporarily attach projectile 300 to the target, absorb an impact force upon impact of projectile 300 with the target, and/or prevent damage to projectile 300 upon impact with the target.

In embodiments, second end 304 may comprise a rearward end of projectile 300. Second end 304 may be oriented toward a projectile launcher upon deployment of projectile 300 toward a target location from the projectile launcher. For example, second end 304 may remain oriented toward projectile launcher 100 with brief reference to FIG. 1. Second end 304 may remain oriented toward the projectile launcher while projectile 300 is in flight toward the target location. Second end 304 may be configured to remain oriented toward the projectile launcher at a time of impact of projectile 300 at the target location. One or more features of projectile 300 may be disposed at second end 304 to enable a propellant to be applied to projectile 300 according to various aspects of the present disclosure.

In embodiments, second end 304 may comprise a lighted end of projectile 300. Projectile 300 may be configured to emit light away from projectile 300 at second end 304. The light may be emitted in a rearward direction oriented opposite first end 302 from second end 304. The rearward direction may be disposed along central axis C in a direction toward second end 304 from first end 302. The light may improve visibility of projectile 300 while the projectile 300 is in flight toward a target location. The light may improve visibility of projectile 300 at a time at which projectile 300 impacts a target at the target location. The light may enable projectile 300 to remain visible while projectile 300 is coupled to a target at a target location. In embodiments, the visibility of projectile 300 may be improved by light emitted at second end 304 independent of a lighting condition in which projectile 300 is deployed. One or more features of projectile 300 may be disposed at second end 304 to enable light to be emitted from projectile 300 according to various aspects of the present disclosure.

In embodiments, a projectile may comprise a housing with one or more hollow interior portions. The one or more hollow interior portions may enable components of the projectile to at least be partially received in the housing. Alternately or additionally, the one or more hollow interior portions may enable components of the projectile to selectively move within the housing. For example, lighted projectile 300 may comprise housing 310. Housing 310 may be configured to at least partially receive one or more components of projectile 300. Housing 310 may comprise at least one inner channel 312 in which the one or more components may be at least partially received. Each component of the one or more components of projectile 300 may be partially or fully enclosed within housing 310. For example, housing 310 may comprise a single inner channel 312 in which both power supply 330 and light source 350 may be disposed. Inner channel 312 may further partially receive projectile head 320 and at least one user interface 370. Housing 310 may comprise a rigid material configured to protect the one or more components during various states of use of projectile 300. Housing 310 may protect the one or more components before projectile 300 is deployed from a projectile launcher, while projectile 300 is in-flight toward a target location, and/or after projectile 300 has contacted a target at the target location. Housing 310 may retain its shape before, during, and/or after deployment of projectile 300. In some embodiments, an end of housing 310 may be disposed at second end 304 of projectile 300.

In embodiments, a shape of a housing of a projectile may be selected to enable the projectile to be received in a magazine prior to being deployed from the magazine. In some embodiments, the housing may have a symmetrical shape about a central axis of the projectile between a first end of the projectile and a second end of the projectile. For example, housing 310 may have a symmetrical shape about central axis C between first end 302 and second end 304. The shape of housing 310 may enable projectile 300 to be received in various rotational orientations within a magazine prior to deployment. For example, housing 310 may have a cylindrical shape. In other embodiments, a housing of a projectile may have other symmetrical and/or complementary shapes relative to a corresponding shape of a portion of a projectile launcher in which the projectile is received prior to deployment.

In embodiments, a housing of a projectile may comprise at least one opening in which a respective component of the projectile may be respectively received. The component may be partially disposed inside the housing via the opening. A portion of the component in the opening may be disposed inside the housing while another portion of the component may protrude from the housing via the opening. The opening may be sized to fixedly or movably receive the component. For example, projectile head 320 may be disposed in opening 314 at a first end of housing 310. A first portion of projectile head 320 may be disposed in a first end of inner channel 312 via opening 314. Upon assembly of projectile 300, a second portion of projectile head 320 may extend from housing 310 beyond opening 314. A size and shape of opening 314 may be selected to fixedly receive the first portion of projectile head 320. The size and shape of opening 314 may prevent movement of projectile head 320 within opening 314 after the first portion of projectile head 320 is received in opening 314. As another example, housing 310 may comprise at least one side opening 318 configured to partially receive user interface 370. A first portion of user interface 370 may be disposed in a central portion of inner channel 312 adjacent a first cavity 312-1 via at least one opening 318. Upon assembly of projectile 300, a second portion of user interface 370 may extend from housing 310 beyond at least one side opening 318. A size and shape of opening 318 may be selected to moveably receive the first portion of user interface 370. The size and shape of opening 318 may enable movement of user interface 370 within opening 314 after the first portion of user interface 370 is received in opening 318. In embodiments, opening 318 may be configured to enable movement of user interface 370 in a predetermined direction. For example, a size and shape of opening 318 may enable movement of user interface 370 in a first direction parallel to axis C. Opening 318 may be further configured to prevent movement of user interface 370 in another direction. For example, a size and shape of opening 318 may prevent movement of user interface 370 in a rotational direction about axis C. While movement in the rotational direction may be prevented by opening, movement in the parallel direction may remain permitted based on a relative physical configuration between opening 318 and user interface 370. In some embodiments, opening 318 may comprise at least two side openings. For example, opening 318 may comprise first side opening 318-1 and second side opening 318-2.

In embodiments, housing 310 may comprise one or more openings by which an internal region of housing 310 may be fluidly coupled to an environment external to housing 310. The one or more openings may enable a force from a propellant to be applied to one or more internal portions of projectile 300. Via the one or more openings, force from the propellant may be applied to at least one component disposed inside housing 310. For example, a propellant comprising an expanding gas may be applied via opening 316 of housing 310 to cause projectile 300 to be deployed from a projectile launcher. Opening 316 may be disposed at a second end of housing 310 opposite a first end of housing 310 at which opening 314 is disposed. Opening 316 may be disposed at second end 304 of projectile opposite first end 302 at which opening projectile head 320 is disposed. In embodiments, opening 316 may enable propellant provided from a source external to projectile 300 to apply a propulsion force to at least one of housing 310, weight 360, light source 350, and/or an internal surface of housing 310 to cause projectile 300 to be deployed from a projectile launcher. In other embodiments, the force from the propellant may alternately and/or additionally be applied to an external portion of housing 310 to cause deployment of projectile 300. In such embodiments, the force may be applied to the external portion of housing 310 independent of whether such a force is further applied by one or more openings of housing 310.

In embodiments, an opening in a housing of a may be configured to pass light emitted by a light source disposed in an internal cavity of a projectile. For example, opening 316 may comprise a circular shape in order to enable to permit light to be evenly emitted about axis C from second end 304. A diameter of opening 316 may be selected to be greater than a diameter light source 350 from which light is emitted. For example, a diameter of opening 316 perpendicular to axis C may be at least 10% larger, at least 25% larger, at least 50% larger, or at least twice the diameter of bulb portion 352 of light source 350 in a same plane perpendicular to axis C.

In embodiments, an inner channel of a housing of a projectile may comprise one or more cavities. Each cavity of the cavities may comprise an unfilled space within the housing. The one or more cavities may enable movement of one or more components of the projectile within the housing. Each cavity of the cavities may be partially defined by an inner surface of the housing. Each cavity of the one or more cavities may be at least partially defined by a component of the projectile. The inner surface and component may at least partially enclose the respective cavity of the one or more cavities. Each cavity of the cavities may comprise an unfilled space within the housing. One or more of the cavities may be fluidly coupled to an external environment in which the projectile is positioned through an opening in the housing. For example, housing 310 may comprise first cavity 312-1. First cavity 312-1 may be disposed in a central portion of inner channel 312. First cavity 312-1 may be defined in part by an interior surface of housing 310. First cavity 312-1 may be partially defined at a first end by projectile head 320. First cavity 312-1 may be partially defined at a second end opposite the first end by one of more of light source 350 and/or weight 360. User interface 370 may be disposed within first cavity 312-1. First cavity 312-1 may enable user interface 370 to translate along axis C within housing 310. First cavity 312-1 may comprise space to enable movement of light source 350 within first cavity 312-1 between a first position associated with an activated state of light source 350 and a second position associated with a deactivated state of light source 350. First cavity 312-1 may be fluidly coupled to an environment exterior to housing 310 via at least one side opening 318. Opening 318 may be disposed in housing 310 in a radial direction from axis C along which light source light source 350 may translate within first cavity 312-1. As an alternate or additional example, housing 310 may comprise second cavity 312-2. Second cavity 312-2 may comprise a second interior portion of inner channel 312. Second cavity 312-2 may comprise an end cavity of housing 310. Second cavity 312-2 may be disposed at an end of inner channel 312. Second cavity 312-2 may be disposed at second end 304 of projectile 300. Second cavity 312-2 may be defined in part by an interior surface of housing 310. Second cavity 312-2 may be partially defined at a first end by light source 350 and/or weight 360. Second cavity 312-2 may be fluidly coupled to an exterior environment at a second end opposite the first end. Opening 314 may be disposed at the second end of second cavity 312-2. In some embodiments, second cavity 312-2 may be fully open to the external environment at the second end. A diameter of second cavity 312-2 at the second end may be equal to a diameter of opening 314 within a same plane. In some embodiments, the diameter of the second end may be equal to a diameter of inner channel 312 along axis C. In other embodiments, a diameter of second cavity 312-2 at second end 304 may be less than a diameter of inner channel 312. Second cavity 312-2 may enable light source 350 to translate along axis C within housing 310. Second cavity 312-2 may comprise space to enable movement of light source 350 within first cavity 312-1 between a first position associated with an activated state of light source 350 and a second position associated with a deactivated state of light source 350. In embodiments, second cavity 312-2 may comprise a portion of inner channel 312 in which a volume of propellant may be received. Second cavity 312-2 may be provided within housing 310 independent of whether projectile 300 is disposed in an activated state or deactivated state. Second cavity 312-2 may comprise a first volume of space within housing 310 in an activated state of projectile 300 and a second volume of space within housing 310 in a deactivated state of projectile 300. The second volume of space may be different from the first volume of space. The second volume of space may be less than the first volume of space. In embodiments, receipt of propellant may cause an increase in a volume of second cavity 312-2.

In embodiments, projectile 300 may comprise a projectile head configured to contact a target at a target location. The projectile head may protect one or more internal components of projectile 300. For example, projectile 300 may comprise projectile head 320. Projectile head 320 may be configured to protect one or more of power supply 330, one or more contacts 340, and/or light source 350 in a direction toward first end 302 from second end 304 of projectile 300. Projectile head 320 may couple with housing 310 at first end 302 to enclose the one or more internal components within housing 310 in the direction toward first end 302 from second end 304. The projectile head may comprise a rigid material, a resilient material, or a combination of a rigid material and a resilient material. For example, and in some embodiments, projectile head 320 may comprise a resilient material configured to at least partially deform upon impact via projectile head 320 of projectile 300 with a target at a target location. In embodiments, a material and/or shape of projectile head 320 may be selected to increase a surface area over which a force of impact of the projectile 300 is applied to the target. Alternately or additionally, the shape and/or material may be selected to decrease a maximum force applied to housing 310 and/or other components of projectile 300 upon impact of projectile head 320 with a target. In embodiments, projectile head 320 may comprise a rigid material configured to withstand a force of impact between projectile 300 and a target. Projectile head 320 may be separate from housing 310 as illustrated in FIG. 3B. Prior to use of projectile 300, projectile head 320 may be rigidly coupled to housing 310 via one or more couplers. However, in other embodiments, and according to various aspects of the present disclosure, projectile head 320 may be integrally formed with housing 310.

In embodiments, a projectile head may comprise a coupler configured to couple the projectile head to another component of a projectile. The coupler may rigidly couple the other component of the projectile. The coupler may mechanically integrate with the other component. In some embodiments, the other component may comprise a complementary coupler. For example, projectile head 320 may comprise first coupler 322. First coupler 322 may comprise a mechanical structure. The mechanical structure may comprise one or more surfaces configured to interfere with one or more other surfaces of another coupler of the projectile. For example, first coupler 322 may comprise one or more ridges disposed along a surface of first coupler 322. First coupler 322 may be configured to mechanically engage second coupler 324 of housing 310. First coupler 322 and second coupler 324 may comprise complementary shapes. For example, second coupler 324 may comprise one or more grooves disposed along an inner surface of housing 310. In other embodiments, housing 310 may lack a second coupler, yet still enable mechanical coupling with first coupler 322 via press fit or other manner of mechanical engagement with at least a portion of housing 310. In some embodiments, at least one of first coupler 322 and/or second coupler 324 may comprise an adhesive to mechanically adhere projectile head 320 to housing 310.

In embodiments, a projectile head of a lighted projectile may comprise a fastener configured to couple the projectile to a target. The fastener may comprise a mechanical fastener. The fastener may be configured to couple to a surface of the target. For example, the fastener may comprise one or more of an adhesive, a hook portion of a hook-and-loop fastener, and/or a loop portion of a hook-and-loop fastener. Alternately or additionally, the fastener may be configured to at least partially penetrate a surface of the target. The fastener may comprise one or more pointed projections configured to pierce the surface of the target. For example, projectile head 320 may comprise at least one fastener 326 with brief reference to FIG. 3B. Fastener 326 may comprise a barbed spear. The fastener may be disposed on an outward facing surface of the projectile head. For example, at least one fastener 326 may be pointed away from projectile 300 in a direction toward which projectile 300 may be deployed toward a target location. At least one fastener 326 may be disposed along central axis C of projectile 300. In other embodiments, a projectile head may lack a fastener. In such embodiments, the projectile may impact a target without being retained on the target. Such a projectile may lack a feature by which the projectile may couple itself to the target. In such embodiments, projectile head 320 may comprise at least one rigid or resilient surface at first end 302 configured to impact a target upon deployment of projectile 300.

In embodiments, a projectile head may comprise a marking material configured to mark a location of impact of a projectile on a target. The marking material may be at least partially disposed on the target by the marking material. For example, the marking material may comprise one or more of an ink or powder. Alternately or additionally, the marking material may comprise an adhesive sheet. The adhesive sheet may comprise an adhesive on a first side of the sheet. A second side of the sheet opposite the first sheet may lack an adhesive and/or include an adhesive having a lower adhesive force than the adhesive on the first side of the sheet. In such embodiments, a force of impact may be sufficient to affix the adhesive sheet to a target, but insufficient to further retain a remaining portion of the projectile on the target. The adhesive sheet may be retained on the target while the remaining portion of the projectile separates from the adhesive sheet and, accordingly, the target after impact.

In some embodiments, the projectile may comprise a material holder that retains the marking material on the projectile head prior to impact. For example, the projectile may comprise a sponge or other porous device in which an ink or powder may be disposed prior to impact. Upon impact, the marking material may be released from the material holder and retained on the target. In other embodiments, the marking material may be directly disposed on a surface of a projectile head during deployment of a projectile. For example, one or more of an ink, powder, and/or adhesive sheet may be disposed on a forward surface of the projectile prior to impact of the projectile and the target.

In embodiments, a projectile head may comprise at least one recess configured to at least partially receive another element of a projectile. For example, projectile head 320 may comprise at least one recess 328. Recess 328 may comprise one or more cavities and/or channels. In embodiments, at least one recess 328 may be formed within projectile head 320. In embodiments, at least one recess 328 may be at least partially enclosed by projectile head 320. In some embodiments, at least one recess 328 may be at least partially further enclosed by an inner surface of housing 310. In other embodiments, at least one recess 328 may alternately or additionally be partially or fully disposed within housing 310 rather than projectile head 320.

In embodiments, at least one recess 328 may be configured to receive at least one stationary element. For example, at least one recess 328 may comprise at least one head cavity 328-1. Head cavity 328-1 may be disposed proximate first end 302 within projectile head 320. Head cavity 328-1 may be configured to receive one or more of power supply 330 and/or one or more contacts 340. Head cavity 328-1 may be configured to retain one or more of power supply 330 and/or one or more contacts 340 in a fixed position within projectile 300. Head cavity 328-1 may comprise a complementary shape relative to respective shape(s) of power supply 330 and/or one or more contacts 340. Head cavity 328-1 may retain at least one element at a fixed position within projectile 300 before and after impact of projectile 300 with a target. Head cavity 328-1 may retain at least one element at a fixed position within projectile 300 independent of whether projectile 300 is disposed in an activated state or a deactivated state. In some embodiments, head cavity 328-1 may comprise a common volume in which a plurality of elements of projectile 300 are disposed.

In embodiments, at least one recess 328 may be configured to receive at least one moveable element. For example, at least one recess 328 may comprise at least one head channel 328-2. Head channel 328-2 may be disposed proximate first end 302 within projectile head 320. In some embodiments, head channel 328-2 may disposed proximate an inner surface of housing 310. Head channel 328-2 may be disposed a distance away from central axis C of projectile 300. Head channel 328-2 may be disposed at a radial distance away from central axis C that is greater than a radial distance away from axis C at which head cavity 328-1 is disposed. In some embodiments, head channel 328-2 may be formed within a surface of projectile head 320 and further enclosed by an inner surface of housing 310. Head channel 328-2 may be configured to receive a moveable portion of one or more of light source 350 and/or weight 360. The moveable portion of the one or more of light source 350 and/or weight 360 may be disposed at different positions within head channel 328-2. The moveable portion of the one or more of light source 350 and/or weight 360 may translate within head channel 328-2. In embodiments, the moveable portion of the one or more of light source 350 and/or weight 360 may move in direction parallel to central axis C of projectile 300. In embodiments, the moveable portion of the one or more of light source 350 and/or weight 360 may engage one or more inner surfaces of head channel 328-2 such that movement of the moveable portion in a direction toward the inner surfaces of head channel 328-2 is prevented. Head channel 328-2 may guide motion of the moveable portion of the one or more of light source 350 and/or weight 360 along a first axis of motion and engage the moveable portion in one or more other axes of motion such that motion in the other axes of motion is prevented. Head channel 328-2 may be configured to moveably retain the moveable portion of one or more of light source 350 and/or weight 360 in an adjustable position within projectile 300. Head channel 328-2 may comprise a complementary shape relative to respective shape(s) of the moveable portion of light source 350 and/or weight 360. Head channel 328-2 may retain at least one element at a moveable position within projectile 300 before and after impact of projectile 300 with a target. Head channel 328-2 may retain at least one element at an adjustable position within projectile 300 independent of whether projectile 300 is disposed in an activated state or a deactivated state.

In embodiments, different recesses of at least one recess 328 may be fluidly coupled to enable two or more elements disposed therein to interact. For example, head cavity 328-1 may be disposed at a first end of head channel 328-2. In accordance with such a relative position, the two or more elements may be enabled to be selectively coupled to each other. For example, one or more contacts 340 disposed in head cavity 328-1 may be selectively mechanically coupled to a moveable portion of light source 350 disposed in head channel 328-2. One or more contacts 340 disposed in head cavity 328-1 may be selectively mechanically coupled to the moveable portion of light source 350 in accordance with a relative, adjustable position of the moveable portion of light source 350 within head channel 328-2. At a first relative position within head channel 328-2, the moveable portion of light source 350 may be mechanically decoupled from one or more contacts 340 disposed in head cavity 328-1. At a second relative position within head channel 328-2, different from the first relative position, the moveable portion of light source 350 may be mechanically coupled with one or more contacts 340 disposed in head cavity 328-1. A mechanical coupling between the moveable portion of light source 350 and the one or more contacts 340 may enable an electrical coupling between the moveable portion of light source 350 and the one or more contacts 340. The electrical coupling may further enable power from power supply 330 to be provided to light source 350. Accordingly, at the first relative position within head channel 328-2, the moveable portion of light source 350 may be electrically decoupled from one or more contacts 340 disposed in head cavity 328-1, disposing projectile 300 in a deactivated state. At the second relative position within head channel 328-2, the moveable portion of light source 350 may be electrically coupled with one or more contacts 340 disposed in head cavity 328-1, thereby disposing projectile 300 in an activated state.

In embodiments, head channel 328-2 may comprise at least two head channels. The at least two head channels may receive different portions of light source 350 and/or weight 360. For example, a first head channel may receive an anode of light source 350. A second head channel may receive a cathode of light source 350, different from a portion of light source 350 disposed in the first head channel of head channel 328-2. In embodiments, the first head channel and second channel of head channel 328-2 may be disposed on opposite sides of projectile 300. For example, the first head channel and second channel of head channel 328-2 may be disposed in surfaces of projectile head 320 and/or housing 310 on opposite sides of central axis C. In some embodiments, the first head channel and the second head channel of at least one head channel 328-2 may be symmetrically positioned on opposite sides of central axis C of projectile 300.

In some embodiments, a respective shape of at least one head channel of the one or more head channels may be selected to prevent a component of the projectile from being received therein. The respective shape may enable a first component of the projectile to be received in the head channel but prevent a second component from entering or otherwise being received within the head channel. For example, a diameter of a head channel of at least one head channel 328-2 may be selected to receive first connector 354-1. The diameter of the first head channel of at least one head channel 328-2 may be selected to prevent bulb portion 352 of light source 350 from being received therein. For example, a diameter of a head channel of at least one head channel 328-2 may be selected to receive second connector 354-2. The diameter of the head channel of at least one head channel 328-2 may be selected to prevent bulb portion 352 of light source 350 from being received therein. In accordance with its shape, the head channel may provide a stop for the second component. For example, a respective shape of a head channel of at least one head channel 328-2 may provide a stop for bulb portion 352 of light source 350. The respective shape of one or more head channels of at least one head channel 328-2 may limit movement of light source 350 in a direction along central axis C toward first end 302 beyond a point at which bulb portion 352 contacts an end of the one or more head channels. In embodiments, alternate or additional elements of a projectile may provide a stop for a switch. For example, one or more of one or more contacts 340 and/or an end of projectile head 320 may provide a physical stop by which an end of a range of movement of a switch of projectile 300 may be defined. In other embodiments according to various aspects of the present disclosure, movement of another portion or portions of a circuit between light source 350 and power supply 330 may be limited by one or more head channels. In yet other embodiments, a physical stop may be disposed along central axis C, separate from head channel 328-2, to limit movement of the other portion or portions of the circuit and/or switch.

In embodiments, a lighted projectile may comprise a power supply. The power supply may provide power used by a light source to emit light from the projectile. The power supply may be disposed within a housing of the projectile. For example, projectile 300 may comprise power supply 330. Power supply 330 may be fully disposed within housing 310.

In embodiments, various types of power supplies may be disposed within a projectile. In some environments, the power supply may be rechargeable. In other embodiments, the power of supply may be disposable. For example, power supply 330 may comprise one or more batteries. The batteries may comprise disposable or rechargeable batteries. For example, and in certain embodiments, power supply 330 may comprise a first battery 330-1 and a second battery 330-2. First battery 330-1 may comprise a first disposable battery. Second battery 330-2 may comprise a second disposable battery. In some embodiments, power supply 330 may be disposed proximate first end 302 of projectile 300. Power supply 330 may be disposed within projectile head 320. Power supply 330 may be disposed within head cavity 328-1. In some embodiments, power supply 330 may be disposed within housing 310 opposite light source 350. Power supply 330 may be disposed in a first direction along axis C within housing 310 and light source 350 may be disposed in a second, opposite direction relative to power supply 330 along axis C within housing 310. In other embodiments, a power supply may be disposed at one or more other locations within a housing of a projectile. For example, and in such other embodiments, the power supply may be disposed in a central portion of the projectile and/or an end of the projectile proximate to a light source of the projectile.

In some embodiments, a projectile may comprise one or more contacts configured to provide a selective connection between a connector and a power supply. The contacts may comprise electrical contacts configured to conduct an electrical signal. The contacts may conduct electrical power between two elements of the projectile. The contacts may be conductive. The contacts may electrically couple two elements of the projectile. The contacts may be part of a switch provided in the projectile. For example, projectile 300 may comprise one or more contacts 340. One or more contacts 340 may comprise first contact 340-1 and second contact 340-2.

In embodiments, one or more contacts 340 may be electrically coupled to power supply 330. First contact 340-1 may be electrically coupled to a first terminal of power supply 330. Second contact 340-2 may be electrically coupled to a second terminal of power supply 330 different from the first terminal. One or more contacts 340 may be fixedly electrically coupled to power supply 330.

In embodiments, one or more contacts 340 may be electrically coupled to light source 350. First contact 340-1 may be electrically coupled to a first connector of light source 350. Second contact 340-2 may be electrically coupled to a second connector of light source 350 different from the first connector. One or more contacts 340 may be selectively electrically coupled to power supply 330. One or more contacts 340 may be selectively electrically decoupled from light source 350 in accordance with a deactivated state of projectile 300. One or more contacts 340 may be selectively electrically coupled from light source 350 in accordance with an activated state of projectile 300.

In embodiments, one or more contacts 340 may electrically couple power supply 330 and light source 350. One or more contacts 340 may enable electrical power to be provided to light source 350 in order to dispose light source 350 in an activated state. Upon electrical decoupling of one or more contacts 340 with power supply 330 and/or light source 350, projectile 300 may be disposed in a deactivated state.

In embodiments, one or more contact of a projectile may comprise adjustable mechanical contacts. The one or more contacts may be each configured to provide a resilient force to improve retention of a connector in electrical communication with a respective contact. Upon mechanical coupling between a contact and a connector, the contact may provide a retention force to the connector that opposes mechanical release of the connector from the contact. In embodiments, the retention force may comprise one or more of a direct contact force, compressive force, and/or frictional force. Each contact of the one or more contacts may be configured to release a respective connector coupled thereto upon application of a force to the connector and/or the contact. For example, one or more contacts 340 may comprise one or more spring contacts and/or resilient elastomers configured to removably retain a respective portion of light source 350.

In embodiments, a contact of the one or more contacts of a projectile may comprise a flexible contact. The flexible contact may comprise a resilient material. For example, each contact of one or more contacts 340 may comprise one or more of a spring contact and/or a conductive elastomer. A connector may be releasably received within a portion of flexible contact. For example, a spring contact may comprise a C-shaped material that defines a central region in which a portion of a connector may be releasably received. As an alternate or additional example, a conductive elastomer may be at least partially deformed by a portion of a connector such that the portion of a connector is releasably received by the conductive elastomer. In some embodiments, the conductive elastomer may apply a compressive force to a portion of a connector to selectively retain the portion of the conductor between the conductive elastomer and a surface of a housing and/or a projectile head of a projectile. The flexible contact may provide a mechanical retention force to a connector received by the contact. The retention force may enable the connector to be removably received by the flexible contact. For example, first contact 340-1 may comprise a first conductive elastomer. Second contact 340-2 may alternately or additionally comprise a second conductive elastomer. Each conductive elastomer may be configured to selectively couple to a respective connector. Each contact of one or more contacts 340 may conduct electrical power from power supply 330 to a received connector of light source 350. The connector may comprise a connector of a light source. For example, first contact 340-1 may selectively receive first connector 354-1. Second contact 340-2 may selectively receive second connector 354-2. Each of the respective connectors of connectors 354 may be further selectively removed from a respective contact of contacts 340.

In embodiments, a projectile may comprise at least one light source. The light source may be configured to emit light from the projectile after the projectile has been deployed from a projectile launcher. The light source may be disposed within a housing of the projectile such that light emitted from the light source may be visible externally from the projectile. Light emitted from the light source may be visible in a direction toward a projectile launcher from which the projectile was launched. In some embodiments, a switch of a projectile may comprise the at least one light source. At least a portion of the light source may be adjusted in accordance with opening and closing the switch according to various aspects of the present disclosure.

In embodiments, the at least one light source may comprise one more light sources. The one or more light sources may comprise a plurality of light sources or, alternately, a single light source. In some embodiments, at least one of the one or more light sources may comprise a light emitting diode (LED). In some embodiments, at least one light source of a projectile may be configured to emit infrared light. Alternately or additionally, the at least one light source may be configured to emit visible light. For example, projectile 300 may comprise light source 350. Light source 350 may further comprise a single LED. Light source 350 may be disposed within inner channel 312 inside housing 310. Portions of light source 350 may be disposed in each of first cavity 312-1 and second cavity 312-2 in embodiments according to various aspects of the present disclosure.

In embodiments, a light source may comprise a bulb portion configured to emit light. For example, light source 350 may comprise bulb portion 352 configured to emit light. In some embodiments, bulb portion 352 may be configured to emit light omnidirectionally from light source 350. In other embodiments, a bulb portion 352 may be configured to emit light in a directional manner. For example, a strongest emission of light for bulb portion 352 may be oriented along a central axis of projectile in a direction away from second end 304. In embodiments, an axis along which a highest magnitude of light is emitted may be oriented in a direction toward a projectile launcher from which projectile 300 was deployed. For example, bulb portion 352 may be disposed within housing 310 to emit a greatest amount of light in a direction along central axis C.

In embodiments, a light source may be integrated in a projectile in a manner that direct emission of light is prevented in one or more directions. For example, light source 350 may be disposed in projectile 300 such that light is not emitted in a direction toward first end 302 from second end 304. In some embodiments, light source 350 may be disposed in projectile 300 such that light is not emitted perpendicularly relative to direction along a central axis C of projectile 300. Bulb portion 352 may be recessed within housing 310 such that walls of housing 310 that enclose inner channel 312 limit a lateral angle away from central axis C in which bulb portion 352 may emit light. In embodiments, bulb portion 352 may be disposed within second cavity 312-2 provided within housing 310.

In embodiments, a bulb portion of a light source may be disposed adjacent to a cavity within a housing of a projectile. The cavity may provide an additional spacing between an end of the housing and the bulb portion, thereby increasing an extent of physical protection to the bulb portion afforded by the housing. For example, projectile 300 may comprise second cavity 312-2 disposed adjacent bulb portion 352. Second cavity 312-2 may be disposed along central axis between first end 302 and second end 304. Bulb portion 352 may be disposed at an inner side of second cavity 312-2 opposite opening 316.

In embodiments, a bulb portion may be recessed within a cavity independent of an activated or deactivated state of a projectile. The bulb portion may be fully recessed within a cavity of the projectile housing independent of whether the bulb portion is configured to emit light or not emit light. The bulb portion may be fully recessed within a cavity of the projectile housing independent of various positions in which the bulb portion may be adjustably positioned inside the housing. For example, a length of second cavity 312-2 along central axis C may be greater than a length of bulb portion 352. A minimum length of second cavity 312-2 along central axis C, corresponding to when light source 350 is disposed in a position associated with a deactivated state, may be greater than a length of bulb portion 352. A length of second cavity 312-2 along central axis C may equal or greater than a length of bulb portion 352 along central axis C when light source 350 is disposed at a position associated with a deactivated state. Such an arrangement may enable housing 310 to protect bulb portion 352, regardless of a state of deployment and/or activation in which projectile 300 may be disposed. When light source 350 is disposed in a position associated with an activated state, light emitted by bulb portion 352 may be emitted through second cavity 312-2 to an environment external to projectile 300.

In embodiments, a light source may comprise one or more connectors. The one or more connectors may electrically couple the light source to a power supply. Each connector of the two or more connectors may be electrically conductive. A connector of the one or more connectors may comprise an anode or cathode of the light source. For example, light source 350 may comprise one or more connectors 354. The one or more connectors 354 may comprise first connector 354-1 and second connector 354-2. In some embodiments, first connector 354-1 may comprise one of a cathode or an anode. Second connector 354-2 may comprise another of the cathode or the anode different from first connector 354-1.

In embodiments, connectors of a light source may comprise a portion of a light source. The connectors may be integrated with another portion of the light source that is configured to emit light. For example, one or more connectors 354 may comprise leads of a light emitting diode (LED). The leads may comprise elongated leads. For example, a length of each of the one or more connectors 354 along central axis C may be at least twice, at least three times, or more than three times longer than a length of bulb portion 352 along central axis C. In other embodiments, the length of each of the one or more connectors 354 along central axis C may be equal or less than a length of bulb portion 352 along central axis C. A length of a connector of one or more connectors 354 may be selected to be greater than a length of user interface 370 along central axis C.

In embodiments, each connector of one or more connectors 354 may be disposed in a respective head channel of a projectile. A connector may be movably received within a respective head channel of the one or more head channels. The component may be enabled to move relative to the head channel. Each head channel of the one or more head channel may be arranged to limit movement of a respective component in one or more directions. For example, a first head channel may receive first connector 354-1. The first head channel may limit movement of first connector 354-1 to a direction parallel to central axis C. The first head channel may prevent movement of first connector 354-1 in other directions radial, perpendicular, or otherwise tangential to a direction between first end 302 and second end 304 along which central axis C is disposed. Further, a second head channel may receive second connector 354-2. The second head channel may limit movement of second connector 354-2 to a direction parallel to central axis C. The second head channel may prevent movement of second connector 354-2 in other directions radial, perpendicular, or otherwise tangential to the direction between first end 302 and second end 304 along which central axis C is disposed. In some embodiments, each head channel of the at least one head channel 328-2 may be aligned with another component of a projectile. The alignment may enable and/or ensure mechanical coupling between the other component and a component received in the guide. For example, the first head channel may be aligned with first contact 340-1. The second head channel may alternately or additionally be aligned with the second contact 340-2. The first head channel may ensure that first connector 354-1 physically couples to first contact 340-1. The second head channel may ensure that second connector 354-2 physically couples to second contact 340-2. In embodiments, the head channels may be disposed in a central region of a projectile. For example, each channel of at least one head channel 328-2 may be disposed in a central region of housing 310. The central region may be disposed between a location within housing 310 at which bulb portion 352 is disposed and a location at which power supply 330 and/or one or more contacts 340 are each respectively disposed.

In embodiments a projectile may comprise a user interface. The user interface may comprise a manual user interface. The user interface may be configured to enable a user to physically adjust one or more elements of a projectile. The user interface may be configured to enable a user to reset one or more elements of a projectile after deployment. The user interface may be configured to enable a user to reposition one or more elements of a projectile between at least two relative positions. The user interface may enable at least one component of the projectile to be moved relative to one or more other components of the projectile. The at least one component may comprise a portion of a circuit between a light source and a power supply. The user interface may be part of a switch of the projectile. The user interface may enable the portion of a circuit to be selectively moved. The portion of the circuit may be repositioned via the user interface. The repositioning may enable a circuit between a light source and a power supply to be disconnected. The light source may be electrically decoupled from the power supply in accordance with actuation of the user interface. The user interface may enable the at least one component of the projectile to be manually repositioned. In embodiments, the user interface may comprise one or more of a toggle, slide, and/or button. For example, projectile 300 may comprise at least one user interface 370. At least a first portion of a user interface may be accessible externally to the projectile. The portion of the user interface may enable the slide to be manually actuated. For example, user interface 370 may comprise two external-facing surfaces. User interface 370 may comprise a first slide 370-1 that may be manually accessible. User interface 370 may comprise a second slide 370-2 that may be manually accessible. First slide 370-1 may provide a first user interface for projectile 300. Second slide 370-2 may provide a second user interface for projectile 300. First slide 370-1 may comprise a first externally-facing surface. Second slide 370-2 may alternately or additionally comprise a second externally-facing surface. The first externally-facing service may be disposed opposite the second externally-facing surface. The first externally-facing service may be symmetrically disposed about central axis C relative to the second externally facing surface.

In embodiments, each slide of a user interface may be disposed through a respective opening of the projectile. For example, user interface 370 may be disposed through one or more respective openings of housing 310. The respective opening may limit a range of motion of the slide. The range of motion may be limited in accordance with a dimension of the respective opening. For example, a dimension of first side opening 318-1 in housing 310 through which first slide 370-1 is disposed may limit a range of motion of first slide 370-1 along central axis C. A dimension of second side opening 318-2 in housing 310 through which second slide 370-2 is disposed may alternately or additionally limit a range a motion of second slide 370-2 along central axis C. A radius of user interface 370 in a direction perpendicular to central axis C may be greater than a radius of housing 310 perpendicular to central axis C. A width of user interface 370 in a direction perpendicular to central axis C may be greater than a width of housing 310 perpendicular to central axis C. In embodiments, a maximum width of user interface 370 in a direction perpendicular to central axis C may be greater than a maximum width of housing 310 perpendicular to central axis C. In embodiments, a dimension of user interface 370 in a direction perpendicular to central axis C may be greater than a dimension of housing 310 perpendicular to central axis C at one or more locations along central axis C at which user interface 370 is disposed.

In embodiments, portions of a user interface be mechanically coupled such that a force of motion applied to one portion may be transferred another portion, thereby causing both portions to move. The two or more portions may be mechanically coupled together. For example, two or more portions of user interface 370 may be fixedly coupled together such that the two or more portions may be repositioned in unison. First slide 370-1 may be rigidly coupled to second slide 370-2. In some embodiments, first slide 370-1 may affixed to second slide 370-2 via one or more of an interference fit, an adhesive, or a mechanical fastener.

In embodiments, a user interface may be configured to selectively reposition a light source. For example, user interface 370 may be configured to physically reposition light source 350. User interface 370 may be disposed adjacent light source 350 within housing 310. User interface 370 may be disposed between light source 350 and a stop. For example, at least one head channel 328-2 and/or projectile head 320 may be disposed on a first side of user interface 370 and light source 350 may be disposed on a second side of user interface 370 opposite the first side. Movement of light source 350 toward first end 302 may cause user interface 370 to physically contact the stop. Movement of user interface 370 in a direction toward light source 350 along central axis C may cause corresponding movement of light source 350. In some embodiments, user interface 370 may be directly or indirectly coupled to light source 350. In other embodiments according to various aspects of the present disclosure, user interface 370 may be directly or indirectly coupled with one or more portions of a circuit between a light emitting element of a projectile and a power supply. In embodiments, the user interface may not be mechanically fixed to the portions of the circuit. In such embodiments, user interface 370 may be selectively disposed in contact with the one or more portions of the circuit, but may not be adhered to the one or more other portions of the circuit. In such embodiments, the user interface may be translated independently of the one or more other portions of the circuit depending on the relative, separate location at which the user interface and the one or more other portions of the circuit are disposed within the projectile. For example, user interface 370 may be disposed adjacent to light source 350 within housing 310. User interface 370 may be selectively disposed in physical contact light source 350 within housing 310. User interface 370 may not be further affixed to light source 350. Movement of user interface 370 toward second end 304 may cause corresponding movement of light source 350 when light source 350 is selectively disposed toward first end 302 and adjacent user interface 370 prior to such movement being applied. When light source 350, or another portion or portions of a circuit, are selectively disposed toward second end 304 instead of first end 302, user interface 370 may be moved independently within housing 310 according to various aspects of the present disclosure. Accordingly, the user interface may enable a unidirectional change in position of the portion(s) of the circuit. The user interface may not enable a bidirectional change in position of the portion(s) of the circuit. Such an arrangement may enable user interface 370 to selectively reposition light source 350 in a desired manner. Such an arrangement may further prevent unintended movement of both the user interface 370 and the light source 350 when projectile 300 is disposed in various orientations prior to deployment of projectile 300. Particularly, and in accordance with user interface 370 being decoupled from light source 350, unintended translation of light source 350 due to one or more slides of user interface 370 may be prevented when projectile 300 is disposed in a vertical orientation otherwise carried in a projectile launcher prior to deployment. In such an orientation, light source 350 may be frictional and/or other interference forces between light source 350 and housing 310 and/or weight 360, independent of a force associated with a movement of user interface 370.

In embodiments, a user interface of a projectile may be at least partially encircled by a portion of a circuit disposed in a projectile. The position of the user interface may enable physical movement of the user interface to apply a corresponding movement to the portion of the circuit. The position of the user interface may maintain a physical spacing and/or electrical isolation of subparts of the portion of the circuit. Movement of the portion of the circuit may electrically open or close the circuit between a light source from a power supply. For example, user interface 370 may be partially encircled by two or more of first connector 354-1, bulb portion 352, and/or second connector 354-2. The two or more of first connector 354-1, bulb portion 352, and/or second connector 354-2 may be disposed on at least two sides of user interface 370. The two or more of first connector 354-1, bulb portion 352, and/or second connector 354-2 may be disposed in at least two directions relative to user interface 370, wherein an angle centered at user interface 370 between the at least two directions is equal or greater than 90 degrees. In some embodiments, the angle between the two directions may be equal or greater than 180 degrees. In embodiments, one or more connectors 354 may be disposed on opposite sides of user interface 370. For example, first connector 354-1 may be disposed on a first side of user interface 370 and second connector 354-2 may be disposed on a second side of user interface 370 opposite the first side. First connector 354-1 may be disposed symmetrically about user interface 370 relative to second connector 354-2. User interface 370 may be centered between first connector 354-1 and second connector 354-2. User interface 370 and bulb portion 352 may be centered along center axis C. Such an arrangement may enable a force applied to user interface 370 to be further coupled to a center of light source 350 in order to evenly apply a force of motion across a surface of light source 350 in physical contact with user interface 370. In embodiments, a length of at least one connector of one or more connectors 354 parallel to central axis C may be greater than a length of a portion of user interface 370 partially encircled by the connector. For example, a length of user interface 370 along central axis C may be less than a length of first connector 354-1 and/or second connector 354-2 along central axis C. In embodiments, a combined width of user interface 370, first connector 354-1, and second connector 354-2 may be substantially equal to a diameter of inner channel 312 in order to enable movement of user interface 370, first connector 354-1, and second connector 354-2 along central axis C, but prevent rotation of at least one of first connector 354-1 and second connector 354-2 toward central axis C.

In embodiments, at least one side of a user interface may be disposed adjacent a non-circuit element of a projectile. The at least one side may enable mechanical contact between the user interface without damaging a portion of a circuit of the projectile. For example, a side of user interface 370 toward first end 302 along central axis may be adjacent one or more of first cavity 312-1 and/or projectile head 320. A portion of a circuit may be disposed proximate this side of user interface 370, but not intermediate this side of user interface 370 and another internal component of projectile 300. In embodiments, the at least one side of user interface 370 may be arranged to mechanically contact the other internal component of projectile 300.

In embodiments, a projectile may comprise a weight. The weight may be movable responsive to one or more forces applied to the projectile. The weight may be moved in a first direction responsive to a first force and moved in a second direction responsive to a second force. The weight may be disposed adjacent to another component of the projectile such that movement of the weight may cause corresponding movement of the other component. For example, projectile 300 may comprise weight 360. Weight 360 may be disposed toward second end 304 of projectile. Weight 360 may be disposed within second cavity 312-2 provided within housing 310. Weight 360 may be configured to movably translate along central axis C within projectile 300. In embodiments, a weight may comprise a rigid material. The rigid material may enable the weight to withstand a propulsive force applied to the seal. For example, weight 360 may comprise one or more metal washers.

Alternately or additionally, a weight may comprise a resilient material. For example, weight 360 may comprise a resilient gasket. The resilient material may be disposed at a surface at which weight 360 is adjacent housing 310. Such an arrangement may provide a fluid seal between weight 360 and an inner surface of housing 310.

In embodiments, a weight may be disposed adjacent to at least one movable portion of an electrical circuit. The weight and the portion of the electrical circuit may be movable relative to other components of the projectile. Movement of the weight may cause corresponding movement of the movable portion of the electrical circuit. For example, weight 360 may be disposed adjacent light source 350. Weight 360 may be disposed adjacent bulb portion 352 of light source 350. In embodiments, weight 360 may be disposed in a radial direction about central axis C relative to bulb portion 352. Weight 360 may be disposed around bulb portion 352. Weight 360 may at least partially encircle bulb portion 352. Weight 360 may fully encircle bulb portion 352. Weight 360 may comprise an inner bore in which a portion of light source 350 may be disposed. In embodiments, bulb portion 352 may be disposed through an inner bore of weight 360. A length of bulb portion 352 may be greater than a length of weight 360 along central axis C. A diameter of one end of bulb portion 352 may be greater than a diameter of an inner bore of weight 360 such that an opposite end of bulb portion 352 may be received through the bore, but the one end may prevent bulb portion 352 from fully passing through the bore. In other embodiments, a weight may be disposed at other positions relative to the movable portion of the circuit. For example, the weight may be disposed between the movable portion of circuit and an end of the projectile; disposed adjacent more, fewer, and/or different surfaces of the movable portion of the circuit; and/or disposed in indirect mechanical communication with the movable portion of the circuit such that a force applied to the weight or the movable portion of the circuit may be transferred via another mechanical component to the other of the weight or the movable portion of the circuit. Alternately or additionally, one or more other portions of a light source may be disposed through a weight. For example, a connector or other conductive electrical path of a light source may be provided through the weight in addition, or as an alternative to, a bulb portion of a light source.

In embodiments, a weight may be separate from another movable component of a projectile. For example, weight 360 may be disposed adjacent to light source 350. Weight 360 may be further unattached to light source 350. Such an arrangement may enable movement of weight 360 independent of light source 350. for example, weight 360 may translate toward second end 304 independent of light source 350 when light source 350 is disposed at a relative position toward first end 302. In other embodiments, a weight may be coupled to the other movable component such that force of motion applied to one of the weight or other movable component causes the other of the weight or movable component to also be translated by the force. For example, weight 360 may be fixed to light source 350 via an adhesive and/or an interference fit between a portion of weight 360 and light source 350. In embodiments, weight 360 may be coupled to light source 350 via glue. An inner bore of weight 360 may be glued to bulb portion 352 of light source 350.

In some embodiments, a projectile may comprise a seal. The seal may be disposed at a deployment end of the projectile. The seal may be configured to fluidly isolate an internal portion of the projectile from an external portion of the projectile. The seal may control transfer of pressurized gas perceived at the deployment end of the projectile to other components of the projectile. The seal may ensure that a force of motion provided by the pressurized gas is received by the projectile in a controlled manner. For example, and in accordance with various embodiments, weight 360 may comprise a seal. Weight 360 may comprise a rubber seal. For example, weight 360 may comprise a resilient material configured to contact an internal surface of housing 310 adjacent a circumference of weight. The resilient material may comprise a gasket disposed between the circumference of weight 360 and the internal surface of housing 310 adjacent the circumference of weight 360. The resilient material may comprise one or more ridges or fins that extend from a body of weight 360 at a location at which weight 360 contacts an inner surface of housing 310. The ridges, fins, or other forms of resilient material may be mechanically biased toward housing 310 along an outer periphery of weight 360 in contact with an inner surface of housing 310 by which inner channel 312 is defined. The resilient material may provide a force of friction that retains the weight 360 at a fixed location along inner channel 312 until a threshold force is applied to weight 360 and/or another portion of a switch of projectile 300. The threshold force may be less than a reset force and/or a propulsion force according to various aspects of the present disclosure. In embodiments, weight 360 may be configured to fluidly isolate second cavity 312-2 disposed proximate a first side of weight 360 from a portion of first cavity 312-1 disposed on a second side of weight 360 opposite the first side.

In other embodiments, a weight may comprise a non-sealing weight. In such embodiments, a side of the weight closest a source of propulsion may receive a force of propulsion from a propellant without fluidly isolating other components of the projectile from the force. In some embodiments, the force of propulsion may be sufficient to cause the weight to move relative to the housing of the projectile. Such a motion may be enabled despite an overall lack of fluid isolation provided by the non-sealing weight. A width of weight 360 perpendicular to axis C may be at least 80% of a width of second cavity 312-2, at least 90% of a width of second cavity 312-2 or at least 95% of a width of second cavity 312-2.

In embodiments, a light may be selectively emitted from a lighted projectile. The selective emission of the light may provide various technical benefits. For example, the selective emission may preserve power while the projectile is disposed in projectile launcher. Alternately or additionally, the selective emission may indicate that a threshold force of propulsion was applied to the projectile during deployment. More generally, light from the lighted projectile may improve visibility of the projectile after the projectile is deployed from the projectile launcher, independent of a lighting condition in which the projectile is deployed.

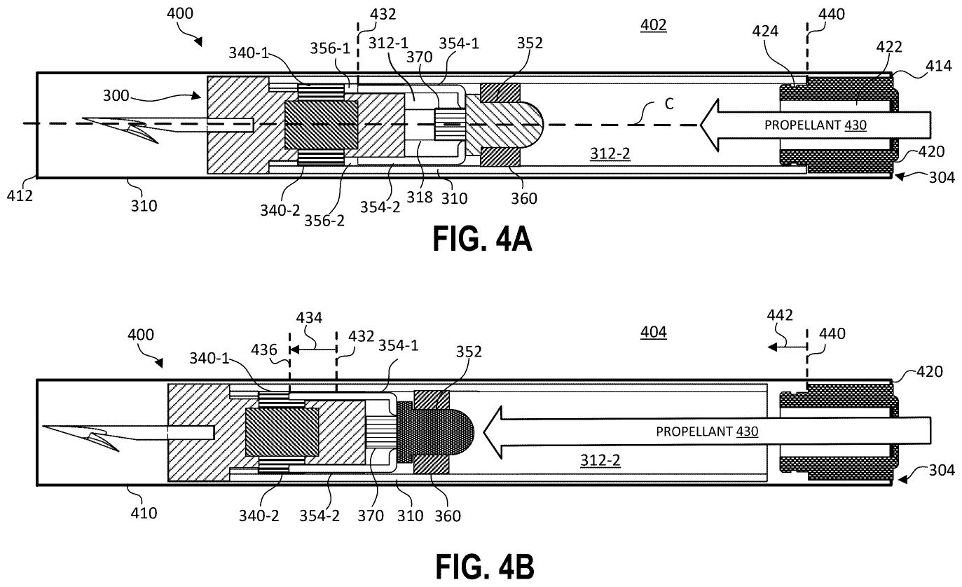

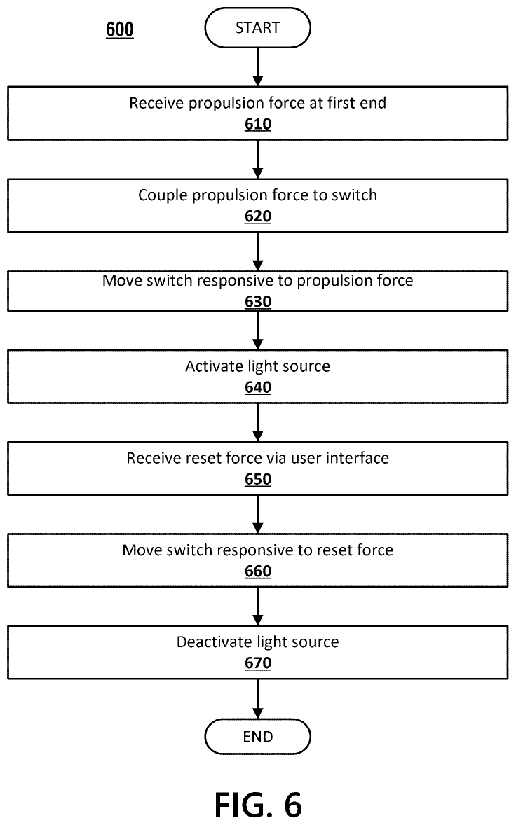

In embodiments according to various aspects of the present disclosure, a method of selectively emitting light from a lighted projectile is provided. For example, and with reference to FIG. 4-6, method 600 may be provided for selectively emitting light from a projectile. Method 600 may be performed by a projectile. For example, method 600 may be performed by each of one or more of projectiles P1-PN, projectile P, and/or projectile 300 with brief reference to FIG. 1-3. Method 600 may comprise one or more operations comprising receiving a propulsion force at a first end 610, coupling a propulsion force to a switch 620, moving a switch responsive to a propulsion force 630, activating a light source 640, receiving a reset force via a user interface 650, moving a switch response to a reset force 660, and/or deactivating a light source 670.

In embodiments, and prior to receiving a propulsion force at a first end 610, a projectile may be disposed in a deactivated state. For example, projectile 300 may be disposed in a deactivated state 402 with brief reference to FIG. 4A. In the deactivated state, light source 350 may be unlit. In a deactivated state, a circuit between a light source and a power supply may be open. For example, one or more connectors 354 may be electrically decoupled from one or more contacts 340. One or more connectors 354 may be physically separated from one or more contacts 340. In some embodiments, both first connector 354-1 and second connector 354-2 may be physically separated from first contact 340-1 and second contact 340-2 respectively. First spacing 356-1 may be provided between first contact 340-1 and first connector 354-1 in accordance with projectile 300 being disposed in the deactivated state. Second spacing 356-2 may be provided between second contact 340-2 and second connector 354-2 in accordance with projectile 300 being disposed in the deactivated state. First spacing 356-1 may comprise a subpart of first cavity 312-1. Second spacing 356-2 may comprise a subpart of first cavity 312-1. In other embodiments, a single conductor may be isolated from a corresponding contact according to various aspects of the present disclosure.

In the deactivated state, an end of one or more connectors 354 may be disposed at a first location 432 along central axis C. For example, an end of first connector 354-1 may be positioned along central axis C at first location 432. Alternately or additionally, an end of second connector 354-2 may be positioned in a same location along central axis C at first location 432. In other embodiments, a location of an end of each of two or more moveable connectors may be offset along a central axis of a projectile. In such embodiments, a length of one connector along the central axis may be greater than a length of another connector along the central axis. In such embodiments, a location at which each connector is positioned along the central axis may provide a non-zero spacing between the ends of the moveable connectors and respective contacts. The non-zero spacing may electrically decouple each respective connector from each respective contact.

In a deactivated state, a projectile may be disposed inside a housing. Prior to receiving the propulsion force at a first end 610, providing the projectile inside the housing may be performed. The housing may comprise one or more of a firing tube, a portion of a magazine, and/or a portion of a cartridge. For example, cartridge 400 may receive projectile 300 in a deactivated state as shown in FIG. 4A. Cartridge 400 may comprise one or more of housing 410 and/or pallet 420. Housing 410 may perform one or more operations of cartridge body 222 with brief reference to FIG. 2. Housing may comprise deployment end 412 and an activation end 414. Deployment end 412 may comprise an opening through which projectile 300 may be deployed from cartridge 400. Activation end 414 may comprise one or more elements through which propellant may be received. Pallet 420 may be disposed at activation end 414. Pallet 420 may be integrated with housing 410 at activation end 414 in a fixed manner. A periphery of pallet 420 may be fluidly sealed to a corresponding surrounding surface of housing 410. Pallet 420 may perform one or more operations of cartridge interface 224 with brief reference to FIG. 2.

In embodiments, a pallet of a cartridge may comprise a bore. The bore may fluidly couple a propellant from an external source to an internal portion of a projectile disposed in the cartridge. For example, pallet 420 may comprise bore 422. Bore 422 may be aligned with central axis C of projectile 300. Bore 422 may receive propellant 430 at an external end. Bore 422 may couple propellant 430 to an internal region of projectile 300 via an internal end of bore 422. In embodiments, a diameter of bore 422 may be constant from the exterior end to the interior end. In embodiments, bore 422 may have a circular cross section in a plan perpendicular to a direction in which propellant 430 is transferred from the external end to the internal end of bore 422.

In embodiments, a pallet of a cartridge may comprise a seat configured to receive a projectile prior to deployment. The seat may comprise one or more features configured to align an inner region of the projectile with a bore of the pallet and/or couple the pallet to the projectile prior to deployment. For example, pallet 420 may comprise seat 424. Seat 424 may be disposed at an internal end of pallet. Seat 424 may comprise an outer periphery of pallet 420 having a recessed shape. A diameter of bore 422 at seat 424 may be less than a diameter of an adjacent, central portion of pallet 420. The recessed shape of seat 424 may be configured to receive second end 304 of projectile 300. The recessed shape of seat 424 may enable the internal end of pallet 420 to be received inside projectile 300. For example, a length of pallet 420 at the internal end may be disposed inside housing 310 when projectile 300 is disposed in cartridge 400 in a deactivated state. A length of the internal end of pallet 420 may extend into second cavity 312-2 when projectile 300 is disposed in cartridge 400 in a deactivated state. A length of housing 310 and the internal end of pallet 420 may overlap in a radial direction along a central axis of projectile 300 at which seat 424 is provided. Alternately or additionally, seat 424 may comprise one or more protrusions configured to engage a second end of a projectile. For example, seat 424 may comprise at least one ridge that encircles pallet 420 proximate the internal end of pallet 420. The at least one ridge may have a raised profile relative to an adjacent region of seat 424. The at least one ridge may exert a contact force in a radial direction when first end 302 of housing surrounds the at least one ridge. A force provided by the at least one ridge of seat 424 may ensure that housing 310 of projectile 300 remains mechanically coupled to pallet 420 after projectile 300 is inserted in housing 410. A retention force provided to housing 310 by the at least one ridge of seat 424 may be overcome by a propulsion force provided to projectile 300 by propellant 430. In embodiments, seat 424 may comprise one or more mechanical surface features configured to releasably retain a provided projectile. Such mechanical surface features may comprise one or more recesses, lips, guides, grooves, slots, and/or protrusions. When a projectile is disposed within a cartridge prior to deployment, the projectile may be disposed at an end location within a seat of the cartridge. For example, second end 304 of projectile 300 may be disposed at first location 440.

In embodiments, a projectile may receive a propulsion force. For example, method 600 may comprise receiving a propulsion force at a first end 610. The propulsion force may be provided via a propellant. For example, and with brief reference to FIG. 4A, propellant 430 may be provided to second end 304 of projectile 300. Propellant 430 may be provided through bore 422 of pallet 420. Propellant 430 may comprise an expanding gas. Propellant 430 may provide a propulsion force to a surface of projectile 300. Receiving 610 may comprise receiving a propellant at a second end of the projectile. For example, receiving 610 may comprise receiving propellant 430 at second end 304. Receiving 610 may comprise receiving propellant via a cartridge interface. For example, propellant 430 may be received by projectile 300 via bore 422 of pallet 420. Receiving 610 may comprise coupling the propellant to a cavity disposed inside the projectile. For example, propellant 430 may be received by second cavity 312-2 within housing 310 of projectile 300. Receiving 610 may comprise receiving a force sufficient to launch projectile 300 from housing 410. Receiving 610 may comprise receiving a force sufficient to unseat a housing of projectile from a cartridge body. For example, the force may unseat housing 310 from seat 424 of pallet 420. Receiving 610 may comprise receiving a propellant from a same end of a projectile from which light is emitted in an activated state of the projectile. Receiving 610 may comprise receiving a propellant through a same opening through which light is emitted after the projectile is deployed. For example, receiving 610 may comprise receiving propellant 430 via opening 316 via which light is emitted from bulb portion 352 after projectile 300 is disposed in an activated state. Receiving 610 may comprise receiving a propellant along a same axis along which light from a light source is emitted. For example, propellant 430 may be received along central axis C from which light from light source 350 is emitted after projectile 300 is disposed in an activated state. In embodiments, the propellant may be received in a direction opposite from a direction in which light is emitted from a projectile. For example, propellant 430 may be received in a direction toward first end 302 from second end 304 of projectile 300, while light from light source 350 may be emitted in a direction toward second end 304 from first end 302 in embodiments according to various aspects of the present disclosure.

In embodiments, a propulsion force may be coupled to a switch of a projectile. For example, method 600 may comprise coupling a propulsion force to a switch 620. The switch may comprise a mechanical switch. The switch may comprise an electrical switch. The switch may comprise an electromechanical switch. Coupling 620 may be performed responsive to receiving 610. The switch may comprise an internal mechanical switch of the projectile. For example, a switch of projectile 300 may comprise light source 350 and weight 360. Coupling 620 may comprise fluidly coupling a propellant to a moveable element disposed internally within the projectile. The moveable element may comprise a portion of the switch of the projectile. For example, coupling 620 may comprise coupling propellant 430 to light source 350 and/or weight 360. Coupling 620 may comprise coupling propellant 430 to a surface of one or more of bulb portion 352 and/or weight 360. For example, a gas pressure of propellant 430 may provide a propulsion force against a surface of weight 360. The gas pressure of propellant 430 may provide a propulsion force to a surface of a portion of light source 350. For example, the propulsion force may be provided to an exterior, rearward-facing surface of bulb portion 352. Coupling 620 may comprise coupling a propellant received at a first, open end of an internal cavity of a projectile to a second, closed end of the internal cavity opposite the first end. The second, closed end may comprise a moveable end of the cavity. In embodiments, coupling 620 may comprise actuating the switch.

In embodiments, a switch of a projectile may be moved responsive to a propulsion force. At least a portion of the switch may be moved responsive to the propulsion force. The portion of the switch may be moved responsive to the propulsion force being coupled to the portion of the switch. The portion of the switch may comprise a moveable portion of the switch. For example, method 600 may comprise moving a switch responsive to a propulsion force 630. Moving 630 may be performed responsive to coupling 620. Moving 630 may comprise moving a portion of a switch comprising light source 350 and/or weight 360. For example, bulb portion 352 and weight 360 may fluidly seal an end of second cavity 312-2. Responsive to coupling 620, a propulsion force provided by propellant 430 may cause bulb portion 352 and/or weight 360 to move light source 350 and weight 360 in a direction opposite from a direction in which propellant 430 is received by projectile 300. In embodiments, another portion of the switch may remain in a fixed position during moving 630. For example, one or more contacts 340 may be retained at a same location within projectile 300 during moving 630.

In embodiments, moving a switch may comprise moving the switch inside a housing of the cartridge. The switch may further move inside a housing of a projectile. The housing of the projectile may comprise an inner channel in which the switch may translate. The housing of the cartridge may further comprise an inner bore in which the projectile is disposed while the switch is moved. The switch may move prior to the deployment of the projectile from the inner bore of the cartridge housing. For example, moving 630 may comprise translating a portion of the switch within housing 410 of cartridge 400 while projectile remains positioned within housing 410. Moving 630 may further comprising moving the portion of the switch of projectile 300 within housing 310. For example, moving 630 may comprise moving light source 350 and weight 360 within housing 310 prior to housing 310 being deployed from housing 410 of cartridge. Moving 630 may comprise translating the switch along a central axis of the projectile. For example, moving 630 may comprise moving a portion of the switch in a direction toward first end 302 from second end 304 along central axis C. An outer periphery of weight 360 may slide along an inner surface of housing 310. A propulsion force provided by propellant 430 may overcome a resistive force provided between an outer periphery of weight 360 and an inner surface of housing 310 that surrounds inner channel 312.

In embodiments, moving 630 may comprise increasing a volume of a cavity of the projectile. The cavity may comprise a cavity fluidly coupled to an opening through which a propellant may be received by a housing of the projectile. For example, moving 630 may comprise increasing a volume of second cavity 312-2. A volume of second cavity 312-2 may increase from a first volume to a second volume. In embodiments, the volume may increase in a linear manner in accordance with a distance along central axis C in which a moveable portion of projectile 300 is moved upon moving 630.

In embodiments, moving 630 may comprise moving at least a portion of the switch in a direction. For example, moving 630 may comprise moving a portion of the switch of projectile 300 in direction 434. The direction may comprise a same direction in which multiple elements of the switch may be moved upon moving 630. For example, direction 434 may comprise a same direction toward first end 302 in which at least light source 350 and weight 360 of a switch of projectile 300 may move. Moving 630 may comprise moving at least a portion of the switch in a parallel direction. For example, direction 434 may comprise a parallel direction in which each of light source 350 and weight 360 of a switch of projectile 300 may move responsive to a propulsion force being applied to projectile 300. In embodiments, the direction may comprise a direction toward an impact end of a projectile. For example, direction 434 may comprise a direction toward first end 302 from second end 304. Accordingly, a direction in which a switch of a projectile may move may comprise a same direction in which the projectile is deployed from a projectile launcher.

In embodiments, the portion of the switch moved upon moving 630 may comprise a user interface. Moving 630 may comprise indirectly applying a force of motion to an element of the projectile. For example, moving 630 may comprise moving a portion of a switch of projectile 300 comprising user interface 370. Moving 630 may comprise at least one of light source 350 and/or weight 360 contacting user interface 370. Moving 630 may comprise transferring a force applied by propellant 430 to light source 350 and/or weight 360 to user interface 370. Moving 630 may comprise moving user interface 370 in direction 434. In embodiments, moving 630 may comprise moving user interface 370 within a respective side opening of housing 310 through which user interface 370 is extended. In embodiments, moving user interface 370 may comprise moving user interface 370 toward a side of a respective side opening disposed toward first end 302. For example, moving 630 may comprise disposing first slide 370-1 toward a side of first side opening 318-1 toward first end 302. In embodiments, moving 630 may comprise moving user interface 370 within at least one side opening 318 of housing 310 through which user interface 370 protrudes. In embodiments, moving 630 may comprise moving a portion of user interface 370 inside housing 310 and another portion of user interface 370 disposed outside housing 310. In embodiments, moving 630 may comprising moving each portion of user interface 370 in unison. User interface 370 may comprise a solid element that moves together upon application of a force to a surface of user interface 370.

In embodiments, the direction in which a switch is moved may comprise a predetermined direction. The predetermined direction may be defined in accordance with a relative physical configuration of portions of the projectile. The relative physical configurations may comprise a relative shape and/or position of the portions of the projectile. For example, one or more connectors 354 may aligned with and/or partially received in head channel 328-2 prior to moving 630. Upon moving 630, a shape of at least one head channel 328-2 may guide each respective connector of one or more connectors 354 in direction 434. Head channel 328-2 may enable direction 434 to be disposed parallel to central axis C. Head channel 328-2 may inhibit movement of one or more connectors 354 in directions different from direction 434.

In embodiments, moving 630 may comprise moving the switch a distance. For example, moving 630 may comprising moving one or more connectors 354 from first location 432 to second location 436. Moving 630 may comprise moving a portion of the switch comprising one or more connectors 354 a distance between first location 432 and second location 436. In embodiments, other portions of the switch may move the distance as well. For example, a distance traversed by each of bulb portion 352 and weight 360 may be equal to a distance between first location 432 and second location 436. First cavity 312-1 may comprise length along central axis C that is equal or greater than the distance between first location 432 and second location 436 to enable movement of bulb portion 352 the distance. A distance between a portion of light source 350 proximate weight 360 and an element of projectile 300 opposite first cavity 312-1 within inner channel 312 may be equal or greater than the distance between first location 432 and second location 436 to enable the portion of light source 350 to move the distance. A distance between bulb portion 352 and projectile head 320 may be equal or greater than the distance between first location 432 and second location 436 to enable bulb portion 352 to move the distance. The distance between first location 432 and second location 436 may be equal to a distance between one or more connectors 354 and one or more contacts 340 prior to a propulsion force being provided to projectile 300. In embodiments, the distance may be equal to a length of at least one of first side opening 318-1 and/or second side opening 318-2 minus a length of user interface 370 respectively disposed within at least one of first side opening 318-1 and/or second side opening 318-2, wherein each length is measured along a direction of movement of the switch upon moving 630.

In embodiments, housing 310 may remain coupled to cartridge via seat 424 while a mechanical switch of projectile 300 is moved. Movement of the switch may occur prior to decoupling of projectile 300 from cartridge 400. Such an arrangement may ensure that an electrical circuit associated with the switch is closed prior to deployment of a projectile.

In embodiments, a light source of a projectile may be activated. The light source may be activated responsive to movement of a switch of the projectile. The light source may begin emitting light in response to the light source being activated. The projectile may be disposed in an activated state in accordance with the light source being activated. For example, method 600 may comprise activating a light source 640. Activating 640 may comprise electrically coupling light source 350 to power supply 330. Activating 640 may comprise closing a circuit between power supply 330 and light source 350. For example, activating 640 may comprise electrically coupling one or more connectors 354 with one or more contacts 340. Activating 640 may be performed responsive to moving 630. Moving 630 may mechanically couple at least two elements of a projectile in a manner that further provides electrical coupling between the at least two elements. For example, light source 350 may be activated upon mechanical coupling between one or more contacts 340 and one or more connectors 354 that electrically couples one or more contacts 340 and one or more connectors 354. The electrical coupling further enables a closed circuit to be provided between power supply 330 and light source 350 via one or more contacts 340 and one or more connectors 354. The electrical coupling further enables power to be provided to bulb portion 352 from power supply 330 via one or more contacts 340 and one or more connectors 354. Responsive to receiving the power, bulb portion 352 may begin emitting light. Bulb portion 352 may initiate emission of light in accordance with activating 640. In accordance with activating 640, the projectile may be disposed in an activated state. For example, activating 640 may comprise emitting light from light source 350 to provide projectile 300 in activated state 404. Activating 640 may comprise emitting light comprising an emission characteristic from light source 350. The emission characteristic may comprise sequence of activations by which the light is emitted. In some embodiments, activating 640 may comprise emitting infrared light. In FIG. 4B, a shading of bulb portion 352 is changed relative to FIG. 4A to illustrate emission of light from light source 350. In embodiments, activating 640 may not be provided until sufficient movement has occurred in accordance with moving 630. In embodiments, light may not be emitted from light source 350 until moving 630 provides movement of a portion of a switch of projectile 300 sufficient to cause an open circuit between power supply 330 and light source 350 to transition to a closed circuit.

In embodiments, activating a light source of a projectile may comprise maintaining the projectile in an activated state. The projectile may remain in the activated state in order to improve visibility of the projectile based in emission of light from the projectile. The projectile may be maintained in the activated state after the projectile is deployed from a cartridge. The projectile may be maintained in the activated state while the projectile is in flight toward a target. The projectile may be maintained in the activated state prior to impact between the projectile and the target. The projectile may be maintained in the activated state upon impact between the projectile and the target. The projectile may be maintained in the activated state after impact between the projectile and the target. The projectile may be maintained in the activated state in accordance with upon impact between the projectile and the target.

In embodiments, maintaining the projectile in the activated state may comprise providing a retention force between at least a portion of a switch and another element of the projectile. For example, activating 640 may comprise removably coupling one or more contacts 340 and one or more connectors 354. An elastic portion and/or spring portion of one or more contacts 340 may provide a contact force that resists physical separation of one or more contacts 340 and one or more connectors 354 after activating 640. Alternately or additionally, a mechanical interference between weight 360 and an inner surface of housing 310 that defines inner channel 312 may provide a sufficient friction force that maintains projectile 300 in the activated state. The retention force may be sufficient to retain a closed circuit between power supply 330 and light source 350 until a predetermined mechanical force is subsequently applied to projectile 300. The retention force may be sufficient to maintain the projectile in the activated state independent of an orientation of the projectile in three-dimensional space.

In embodiments, activating a projectile may comprise deploying the projectile. For example, activating 640 may comprise deploying projectile 300 from cartridge 400. Projectile 300 may be deployed from cartridge 400 after a propulsion force has been applied to a portion of a switch of projectile 300. Propellant 430 may be received after movement of portion of the switch has been initiated upon moving 630. Propellant 430 may be received after movement of portion of the switch has been completed responsive to moving 630. A propulsion force provided by propellant 430 may cause movement of housing 310 within housing 410. The propulsion force may cause housing 310 to be deployed from cartridge 400 toward a remote location. In embodiments, a direction of deployment may be a same direction in which a portion of the switch was moved upon moving. For example, direction 442 may comprise a same direction as direction 434 with brief reference to FIG. 4B. In embodiments, a same force applied to a projectile to activate a light source of the projectile may further propel the projectile from a projectile launcher. In embodiments, the projectile may automatically activate in response to receiving a propulsion force. The projectile may automatically begin to emit light and deploy from a projectile launcher responsive to a propellant being received by the projectile.

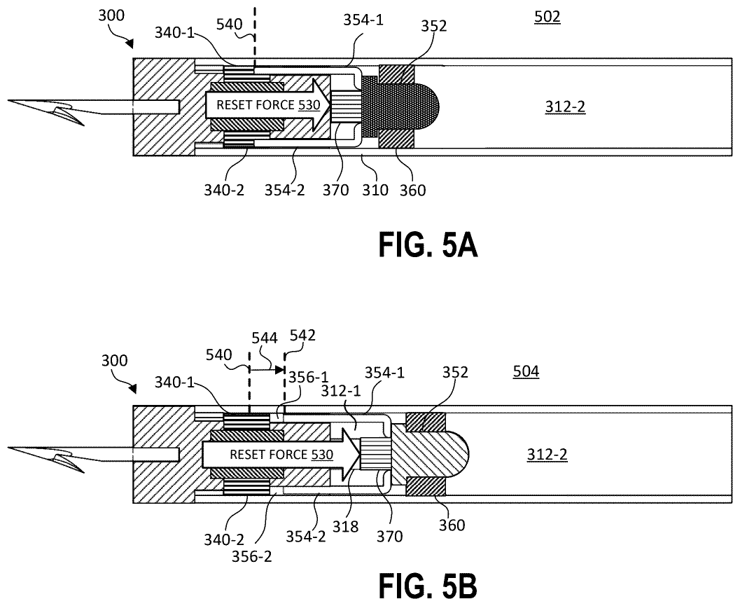

In embodiments, emission of light from a lighted projectile may be selectively terminated. The selective termination of the light may provide various technical benefits. For example, the selective termination may enable power to be preserved after the projectile has been found after deployment of the projectile. The selective termination may enable power of the projectile to be preserved while the projectile is not in use and/or between deployments of the projectile from a projectile launcher. In embodiments, terminating emission of light from a projectile may comprise selectively deactivating the projectile. In embodiments, selectively deactivating a projectile may comprise one or more of receiving a reset force via a user interface 650, moving a switch response to a reset force 660, and/or deactivating a light source 670. Selectively deactivating the projectile may comprise a subset of operations of method 600. Prior to deactivation, the projectile may be disposed in an activated state. The projectile may be provided in the activated state in accordance with a subset of operations of method 600 associated with disposing the projectile in the activated state. For example, the projectile may be disposed in an activated state in accordance with one or more of operations 610-640 being performed by the projectile. Projectile 300 may be disposed in activated state 502 prior to selective deactivation of projectile with brief reference to FIG. 5A. Activated state 502 may correspond to activated state 404 with brief reference to FIG. 4B. In activated state 502, light may be emitted from light source 350. In deactivated state 504, a closed circuit may be provided between light source 350 and power supply 330.

In embodiments, a reset force may be received by a projectile. Prior to receiving the reset force, the projectile may be disposed in an activated state. The reset force may comprise a physical force. The reset force may be received via a different part of a switch by which a propulsion force is received. For example, method 600 may comprise receiving a reset force via a user interface 650. The reset force may comprise a contact force received via the user interface. The reset force may be manually applied via the user interface. For example, receiving 650 may comprise receiving a reset force via user interface 370. User interface 370 may be mechanically actuated to provide the reset force. The mechanical actuation may be manually applied by a user of projectile 300. In embodiments, reset force 530 may be provided to a side surface of user interface 370 toward first end 302 from second end 304. In embodiments, reset force 530 may be provided to a side surface of user interface 370 toward first end 302 from second end 304. In embodiments, user interface 370 may be at an end of side opening 318 of housing 310 toward first end 302 distal from second end 304.

In a deactivated state, an end of one or more connectors 354 may be disposed at a same location along central axis C. For example, an end of first connector 354-1 may be positioned along central axis C at first location 540. Alternately or additionally, an end of second connector 354-2 may be positioned in a same location along central axis C at first location 540. In other embodiments, a location of an end of each of two or more moveable connectors may be offset along a central axis of a projectile. In such embodiments, a length of one connector along the central axis may be greater than a length of another connector along the central axis. In such embodiments, a location at which each connector is positioned along the central axis may provide a mechanical coupling between one or more ends of the moveable connectors and respective contacts. The lack of spacing may electrically couple each respective connector with each respective contact.

In embodiments, receiving 650 may be performed while a projectile is disposed external to a cartridge. For example, and with brief reference to FIG. 5A, reset force 530 may be applied to projectile 300 while projectile 300 removed from a housing. Reset force 530 may be applied while projectile 300 is disposed in a pre-launch and/or post-launch state. Reset force 530 may be applied prior to projectile 300 being inserted or reinserted into a housing from which projectile 300 may be deployed. Deploying a projectile may comprise exposing a user interface by which a reset force may be provided. For example, prior to deployment of projectile from a magazine or cartridge body, user interface 370 may not be externally accessible. The magazine or cartridge body may preclude physical access to user interface 370 when projectile 300 is received in the magazine or cartridge body. For example, housing 410 may enclose user interface 370 in a manner that prevents manual access to user interface 370 while projectile 300 is received in cartridge 400. In embodiments, the projectile may be disposed in a deactivated state prior to being inserted in the magazine or cartridge body. For example, and with brief reference to FIG. 5A, an external force may not be directly applied to user interface 370 while projectile 300 is received in housing 410 with brief reference to FIG. 4A. User interface 370 may be blocked from external access while enclosed by housing 410 independent of whether projectile 300 is disposed in deactivated state 402 or activated state 404 with brief reference to FIG. 4A-B. In embodiments, user interface 370 may be physically accessible for application of a reset force after projectile 300 is disposed in activated state 404 and further fully deployed from housing 410.

In embodiments, the reset force may be received from a direction opposite a direction in which projectile was deployed from a projectile launcher. For example, and with brief reference to FIG. 5B, reset force 530 may be received in a direction toward second end 304 from first end 302.

In embodiments, receiving 650 may comprise receiving reset force 530 at two or more portions of user interface 370. For example, each of first slide 370-1 and second slide 370-2 may extend through a respective side opening of at least one side opening 318. Receiving 650 may comprise receiving reset force 530 on a portion of first slide 370-1 extended through first side opening 318-1 and a portion of second slide 370-2 extended through second side opening 318-2. Reset force 530 may be received in a direction perpendicular to a direction at which each of user interface 370 extend from projectile 300. For example, reset force 530 may be received in a direction toward first end 302 along central axis C, while each of first slide 370-1 and second slide 370-2 may extend perpendicular to central axis C. Such an arrangement may enable reset force 530 to be applied in a balanced manner to user interface 370. In other embodiments, receiving the reset force may comprise receiving the reset force via at least one extended slide of a user interface, independent of whether the user interface comprises one or more extended slides.

In embodiments, a switch of a projectile may be moved responsive to a reset force. Moving the switch may comprise moving a moveable portion of the switch. For example, method 600 may comprise moving a switch response to a reset force 660. The switch may comprise a mechanical, electrical, or electromechanical switch. The switch may comprise a same switch by which the projectile may be disposed in an activated state. Moving the switch may comprise moving a portion of the switch. For example, moving 660 may comprise moving a portion of a switch comprising light source 350, weight 360, and user interface 370. Another portion of the switch may remain in a same position during the moving. For example, a location of one or more contacts 340 within projectile 300 may remain unchanged during moving 660.

In embodiments, moving the switch may comprise mechanically decoupling two or more elements of the projectile. Moving 660 may provide a non-zero spacing between the two or more elements. For example, moving 660 may comprise mechanically decoupling one or more contacts 340 and one or more connectors 354. Moving 660 may at least introduce a first non-zero spacing between first contact 340-1 and first connector 354-1. In some embodiments, moving 660 may further comprise creating a first non-zero spacing between first contact 340-1 and first connector 354-1 and a second non-zero spacing between second contact 340-2 and second connector 354-2. In embodiments, moving 660 may comprise overcoming a retention force between elements of the projectile. For example, moving 660 may comprise overcoming a retention force applied to one or more connectors 354 via one or more contacts 340 prior to receiving 650.

In embodiments, moving the switch may comprise electrically decoupling two or more elements of the projectile. The two more elements may comprise conductive elements of the projection. Moving 660 may provide a non-zero spacing between the two or more elements. In accordance with the non-zero spacing, a circuit provided by the two or more elements may be opened. For example, moving 660 may comprise electrically decoupling one or more contacts 340 and one or more connectors 354. Moving 660 may at least open a circuit between first contact 340-1 and first connector 354-1. In some embodiments, moving 660 may further comprise opening a circuit between each of first contact 340-1 and first connector 354-1, as well as a second contact 340-2 and second connector 354-2.

In embodiments, the switch may be moved in a direction opposite a direction in which the portion of the switch was moved to activate the projectile. For example, and with brief reference to FIG. 5B, the switch may move in direction 544 responsive to reset force 530. Direction 544 may be opposite direction 434 with brief reference to FIG. 4B. In embodiments, direction 544 may be parallel to a central axis C of projectile 300. In embodiments, each element of the portion of the switch may move in direction 544 responsive to reset force 530 received upon receiving 650.

In embodiments, moving 660 may comprise moving the switch a distance. For example, moving 660 may comprising moving one or more connectors 354 from first location 540 to second location 542. Moving 660 may comprise moving a portion of the switch comprising one or more connectors 354 a distance between first location 540 and second location 542. In embodiments, other portions of the switch may move the distance as well. For example, a distance traversed by each of bulb portion 352 and weight 360 may be equal to a distance between first location 540 and second location 542. First cavity 312-1 may comprise length along central axis C that is equal or greater than the distance between first location 540 and second location 542 to enable movement of bulb portion 352 the distance. In embodiments, a distance between first location 540 and second location 542 may be equal to a distance between first location 440 and second location 436 with brief reference to FIG. 4B. In embodiments, the distance may be equal to a length of a side opening 318 minus a length of user interface 370 respectively disposed within at least one of side opening 318, wherein each length is measured along a direction of movement of the switch upon moving 660. In embodiments, a distance between first location 540 and second location 542 may be equal or greater than a minimum distance associated with electrically decoupling one or more contacts 340 from one or more connectors 354.

In embodiments, moving a switch may comprise moving a portion of a switch indirectly. For example, moving 660 may comprise receiving reset force 530 via user interface 370. User interface 370 may further transfer the reset force to one or more other elements of the switch. For example, moving user interface 370 may in turn cause light source 350 and/or weight 360 to move. User interface 370 may push light source 350 and/or weight 360 responsive to the reset force received upon receiving 650. Moving user interface 370 a distance along opening 318 may cause other portions of the switch of projectile 300 to move at least a same distance. Moving 660 may comprise moving user interface 370 from an end of opening 318 toward first end 302 to an opposite end of opening 318 along a central axis C of projectile 300.

In embodiments, moving the switch may comprise applying a force of motion between parts of the switch. For example, moving 660 responsive to receiving 650, user interface 370 may contact light source 350 between first connector 354-1 and second connector 354-2. User interface 370 may contact light source 350 at a base of bulb portion 352. User interface 370 may contact light source 350 at a location at which each of first connector 354-1 and second connector 354-2. In embodiments, moving 660 may comprise moving light source 350 by applying a force at a location on light source 350 partially encircled by at least two of bulb portion 352 first connector 354-1, and/or second connector 354-2.

In embodiments, a light source of a projectile may be deactivated. Upon being deactivated, the light source may cease to emit light. The light may be emitted prior to the light source being deactivated. The light source may be deactivated responsive to moving a switch of the light source. For example, method 600 may comprise deactivating a light source 670. Deactivating 670 may be performed responsive to moving 660. Deactivating 670 may comprise electrically decoupling light source 350 from power supply 330. Deactivating 670 may comprise opening a circuit between power supply 330 and light source 350. For example, deactivating 670 may comprise electrically decoupling one or more connectors 354 from one or more contacts 340. Deactivating 670 may be performed responsive to moving 660. Moving 660 may mechanically decouple at least two elements of a projectile in a manner that further electrically decouples the at least two elements. For example, light source 350 may be deactivated upon mechanical decoupling between one or more contacts 340 and one or more connectors 354 that, in turn, electrically decouples one or more contacts 340 and one or more connectors 354. The electrical decoupling provides an open circuit between power supply 330 and light source 350 in accordance with a spacing being established between one or more contacts 340 and one or more connectors 354. The electrical decoupling further disables power from being provided to bulb portion 352 from power supply 330 via one or more connectors 354. Responsive to no longer receiving the power, bulb portion 352 may stop emitting light. In accordance with deactivating 670, the projectile may be disposed in a deactivated state. For example, deactivating 670 may comprise non-emission of light from light source 350 to provide projectile 300 in deactivated state 504. In FIG. 5B, a shading of bulb portion 352 is changed relative to FIG. 5A to illustrate non-emission of light from light source 350 in accordance with deactivated state 504.

In embodiments, deactivating 670 may not be performed until sufficient movement has occurred in accordance with moving 660. In embodiments, light may not be emitted from light source 350 after moving 660 provides movement of a portion of a switch of projectile 300 sufficient to cause a closed circuit between power supply 330 and light source 350 to transition to an open circuit.

In embodiments, deactivating a light source of a projectile may comprise maintaining the projectile in a deactivated state. The projectile may remain in the deactivated state in order preserve energy of a power supply of the projectile. The projectile may be maintained in the deactivated state after a reset force is received. The projectile may be maintained in the deactivated state independent of whether projectile is subsequently disposed in a housing of a projectile. For example, projectile 300 may remain in deactivated state 504 independent of whether projectile 300 is inserted into a firing tube, magazine, and/or housing 410 with brief reference to FIG. 4A. The projectile may be maintained in the deactivated state until a propulsion force is subsequently received by the projectile.

In embodiments, maintaining the projectile in the deactivated state may comprise providing a retention force between at least a portion of a switch and another element of the projectile. For example, deactivating 670 may comprise providing a retention force between weight 360 and an inner surface of housing 310 by which inner channel 312 is defined. In some embodiments, the retention force may comprise a contact force and/or a mechanical interference between weight 360 and the inner surface of housing 310. Weight 360 may comprise an elastic material at an outer periphery of weight 360 that moveably couples to the inner surface of inner channel 312. Weight 360 may comprise a resilient material that is self-urged against an inner surface along an inner end of second cavity 312-2. The retention force may comprise a threshold retention force that is greater than a force of gravity. The threshold force may prevent movement of weight 360 independent of an orientation in which projectile 300 is disposed after projectile 300 is disposed in a deactivated state. The threshold force may be sufficient to hold weight 360 in place until a propulsion force is received by projectile 300. The propulsion force may overcome the retention force provided between weight 360 and housing 310. In embodiments, weight 360 may be secured to light source 350. The retention force between weight 360 and housing 310 may maintain light source 350 in a position associated with the deactivated state in accordance with a fixed coupling between light source 350 and weight 360.

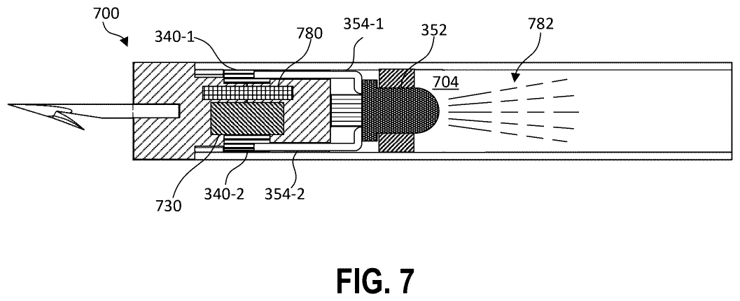

In embodiments, a lighted projectile comprising a predetermined emission characteristic may be provided. For example, and with brief reference to FIG. 7, lighted projectile 700 may be configured to emit light comprising predetermined emission characteristic 782. Emission characteristic 782 may be selected to improve detection of projectile 700. Projectile 700 may comprise features and/or be configured to perform one or more operations of a lighted projectile as discussed elsewhere herein. For example, and with brief reference to FIG. 3A-3B, projectile 700 may comprise a switch with a moveable portion as further discussed with regards to projectile 300.

In embodiments, emission characteristic 782 may be emitted when projectile 700 is disposed in activated state 704. To be disposed in activated state 704, one or more operations may be selectively performed by projectile 700. For example, and with brief reference to FIG. 4A-4B, such operations may comprise one or more operations discussed with regards to disposing projectile 300 in activated state 404.

In embodiments, emission characteristic 782 may comprise a spectrum of light. For example, emission characteristic 782 may comprise an infrared light. At least one light source of projectile 700 may be configured to emit light with emission characteristic 782 in an infrared spectrum. For example, bulb portion 352 of projectile 700 may be configured to emit light with wavelengths in an infrared spectrum. The emitted light may lack wavelengths in a visible spectrum of light. In accordance with emission characteristic 782 comprising infrared light, projectile 700 may be visible to a camera or another optical detection device. However, by emitting infrared light and not emitting visible light, light from projectile 700 may remain non-visible to a human eye when projectile 700 is disposed in activated state 704.

In other embodiments, emission characteristic 782 may comprise visible light. At least one light source of projectile 700 may be configured to emit light with wavelengths in a visible spectrum of light. In such embodiments, a user of a projectile launcher from which projectile 700 is deployed may be able to see emission characteristic 782 from projectile 700 after projectile 700 has been deployed from the projectile launcher.

In embodiments, emission characteristic 782 of light may comprise a frequency at which light is emitted from projectile 700. An intensity of the light may alternate in accordance with the frequency. For example, the light may alternate between states in which light is emitted and not emitted in accordance with the frequency. The frequency may be selected to enable detection by a human eye. For example, and in some embodiments, the frequency may be between 1 Hz and 90 Hz. In accordance with the frequency, optical detection of projectile 700 may be improved after projectile 700 is deployed toward a remote location. In other embodiments, the frequency may be selected in accordance with detection characteristics of an optical detection device configured to detect projectile 700.

In embodiments, emission characteristic 782 of light may comprise a sequence of activations. Upon being disposed in an activated state, a projectile may emit light in accordance with the sequence of activations. The projectile may remain in the activated state while the sequence of activations is generated. An activation may comprise an increase and a decrease in an amount of light emitted by a light source. For example, an activation may comprise a pulse of emitted light. An emission of light from a light source may vary in accordance with the sequence of activations. The sequence may comprise a pattern of activations. Two or more activations in the sequence of activations may be different. For example, two or more activations of the sequence of activations may comprise a different duration. For example, a first activation may comprise a first emission of light for a first number of milliseconds and a second activation may comprise a second emission of light for a second number of milliseconds different from the first number. The second number may be greater or less than the first number. In some embodiments, the sequence may comprise one or more additional activations. Each additional activation may comprise a duration that is the same or different from a duration of each other activation of a sequence of activations that includes the first activation and the second activation. In accordance with the sequence of activations, optical detection of projectile 700 may be improved after projectile 700 is deployed toward a remote location.

In some embodiments, emission characteristic 782 of light of the sequence of activations may be repeated. The sequence of activation may comprise a repeated sequence of activations. For example, the sequence of activations may comprise a series of activations that are repeated over time. A duration for which light is emitted for each activation in the series of activations may be repeated for a corresponding activation in each subsequent series of activations over time. In accordance with a repeated sequence of activations, optical detection of projectile 700 may be improved after projectile 700 is deployed toward a remote location.

In some embodiments, a sequence of activations may comprise a code. For example, the code may comprise one of binary code or Morse code. The sequence of activations may correspond to one or more characters of the code. For example, the sequence of activations may correspond to one or more numbers or letters as separately defined for the code. In accordance with the code, the emission characteristic 782 of light may be translated into a computer-readable or human readable format. In some embodiments, the code may identify projectile 700. For example, the code may indicate one or more of a serial number of projectile 700 or other unique identifier of projectile 700.

In some embodiments, emission characteristic 782 of light may be unique for projectile 700. Emission characteristic 782 may be different for each projectile deployed from a projectile launcher. Emission characteristic 782 may be different relative to an emission characteristic of a projectile deployed by a projectile launcher different from a projectile launcher from which projectile 700 is deployed. Emission characteristic 782 may be unique in accordance with a frequency, amplitude, wavelength, and/or sequence of activations relative to corresponding frequency, amplitude, wavelength, and/or sequence of activations of light emitted from another other projectile. In accordance with a unique emission characteristic, a given projectile 700 may be optically distinguished from other projectiles, including those previously or subsequently deployed from a same or different projectile launcher. For example, a camera system separate from projectile 700 may be configured to separately identify each of a plurality of separate projectiles deployed based on a unique emission characteristic of each projectile of the plurality of separate projectiles. In some embodiments, the camera system may enable, for example, an accuracy of each projectile of a series of deployed projectiles to be tracked relative to a target at a remote location.

In embodiments, projectile 700 may comprise a circuit 780 configured to control emission characteristic 782 of light emitted from projectile. Circuit 780 may comprise microcontroller. Alternately or additionally, circuit 780 may comprise a micro-electronic circuit. In some embodiments, circuit 780 may be configured as a processing circuit that comprises circuitry and/or an electrical or electronic subsystem for performing a function of the projectile. A processing circuit may include circuitry that performs a stored program. A processing circuit may include a digital signal processor, a microcontroller, a microprocessor, an application specific integrated circuit, a programmable logic device, logic circuitry, state machines, MEMS devices, signal conditioning circuitry, data busses, address busses, and/or a combination thereof in a quantity suitable for performing a function and/or executing one or more stored programs. In embodiments, circuit 780 may include passive electronic devices (e.g., resistors, capacitors, inductors) and/or active electronic devices (op amps, comparators, analog-to-digital converters, digital-to-analog converters, programmable logic, transistors). In some embodiments, circuit 780 may include data buses, output ports, input ports, timers, memory, and arithmetic units. In embodiments, circuit 780 may provide and/or receive electrical signals in digital and/or analog form.

In embodiments, circuit 780 may be disposed in series with at least one light source from which light with the emission characteristic 782 is emitted. For example, circuit 780 may be disposed in series with a light source comprising bulb portion 352 and first connector 354-1. Circuit 780 may be electrically coupled to bulb portion 352 via first connector 354-1.

In embodiments, circuit 780 may be further disposed in a circuit comprising at least one light source and a power supply of projectile 700. For example, circuit 780 may be disposed in an electrical circuit comprising a first terminal of power supply 730, circuit 780, first contact 340-1, first connector 354-1, bulb portion 352, second connector 354-2, second contact 340-2, and a second terminal of power supply 730. Electrical power from power supply 730 may be provided to, or received from, the at least one light source of projectile 700 via circuit 780.

In embodiments, circuit 780 may be configured to control emission characteristic 782 by modifying a signal provided by power supply 730 for the light source. For example, circuit 780 may modify an amplitude and/or a frequency of a power supply signal provided by power supply 730. Power supply 730 may provide a power supply signal comprising at a constant frequency and/or amplitude over time. Circuit 780 may modify this power supply signal to have a different frequency and/or amplitude over time. The power supply signal may be modified in accordance with a configuration of circuit 780. For example, circuit 780 may comprise an oscillator by which an input signal is modified to provide an output signal. The modified power supply signal may be applied to at least one light source of projectile 700. In accordance with the modified power supply signal, the light of projectile 700 may emit light with emission characteristic 782.

In embodiments, circuit 780 may be at least partially disposed in a non-moveable portion of projectile 700. For example, circuit 780 may be disposed in a projectile head of projectile 700. Circuit 780 may remain in a static relative position within projectile 700 before, during, and after deployment of projectile 700.

In some embodiments, circuit 780 may be at least partially disposed in a moveable portion of projectile 700. For example, circuit 780 may be disposed in a moveable portion of a switch of projectile 700. Circuit 780 may be physically coupled, for example, to one or more of first connector 354-1, bulb portion 352, second connector 354-2 or other moveable portion of a switch of projectile 700. A position of circuit 780 within projectile 700 may change when projectile 700 transitions between a deactivated state and activated state 704.

In some aspects, the techniques described herein relate to a lighted projectile including: a housing having an opening configured to receive a provided propellant; a switch including a moveable portion disposed within the housing; and a light source, wherein the moveable portion of the switch is configured to perform operations including: moving in response to the provided propellant being received via the opening of the housing; and in response to the moving, activating the light source.

In some aspects, the techniques described herein relate to a lighted projectile, wherein the moveable portion includes the light source.

In some aspects, the techniques described herein relate to a lighted projectile, wherein the moveable portion includes a weight.

In some aspects, the techniques described herein relate to a lighted projectile, wherein the weight includes a resilient material.

In some aspects, the techniques described herein relate to a lighted projectile, wherein the weight is disposed in an inner channel of the housing and the resilient material provides a retention force between the weight and an inner surface of the housing along the inner channel.

In some aspects, the techniques described herein relate to a lighted projectile, wherein the weight includes a rubber seal.

In some aspects, the techniques described herein relate to a lighted projectile, wherein the weight is fixedly coupled to the light source.

In some aspects, the techniques described herein relate to a lighted projectile, wherein the light source includes a bulb portion, and the weight includes an inner bore in which the bulb portion is disposed.

In some aspects, the techniques described herein relate to a lighted projectile, further including at least one contact, wherein the moving includes electrically coupling the light source to the at least one contact.

In some aspects, the techniques described herein relate to a lighted projectile, wherein each contact of the at least one contact includes a conductive elastomer.

In some aspects, the techniques described herein relate to a lighted projectile, wherein the light source includes at least one connector, wherein the moving includes moving the at least one connector.

In some aspects, the techniques described herein relate to a lighted projectile, further including a projectile head disposed at first end of the lighted projectile, wherein the opening is provided at a second end of the lighted projectile opposite the first end.

In some aspects, the techniques described herein relate to a lighted projectile, wherein the projectile head includes at least one head channel in which the moveable portion of the switch is received.

In some aspects, the techniques described herein relate to a lighted projectile, further including at least one contact disposed at a first end of the at least one head channel opposite a second end of the at least one head channel through which the moveable portion is received.

In some aspects, the techniques described herein relate to a lighted projectile, wherein the projectile head includes at least one head cavity, and wherein the lighted projectile includes at least one power supply disposed in the at least one head cavity.

In some aspects, the techniques described herein relate to a lighted projectile, wherein the projectile head includes a fastener disposed at a first end of the projectile head opposite a second end of the projectile head at which the projectile head is coupled to the housing.

In some aspects, the techniques described herein relate to a lighted projectile, further including at least one power supply disposed in the housing.

In some aspects, the techniques described herein relate to a lighted projectile, further including a user interface extending through at least one side opening of the housing.

In some aspects, the techniques described herein relate to a lighted projectile, wherein a portion of the user interface is disposed adjacent to the light source.

In some aspects, the techniques described herein relate to a lighted projectile, wherein the operations further include: moving in a response to a reset force received via the user interface; and responsive to moving in response to the reset force, deactivating the light source.

In some aspects, the techniques described herein relate to a lighted projectile, wherein the light source includes two electrical connectors, and the user interface is disposed between the two electrical connectors.

In some aspects, the techniques described herein relate to a lighted projectile, further including a cavity fluidly coupled to the opening.

In some aspects, the techniques described herein relate to a lighted projectile, wherein the moveable portion is disposed on a first side of the cavity opposite a second side of the cavity at which the opening is fluidly coupled to the cavity.

In some aspects, the techniques described herein relate to a lighted projectile, wherein moving the moveable portion includes increasing a volume of the cavity.

In some aspects, the techniques described herein relate to a lighted projectile, further including a cavity disposed within the housing between the moveable portion of the switch and a first end of the lighted projectile opposite a second end of the lighted projectile through which the provided propellant is received.

In some aspects, the techniques described herein relate to a projectile launcher including: a projectile including a light source and a switch; a housing configured to receive the projectile; and a propulsion source fluidly coupled to the projectile to provide a propellant, wherein the projectile is configured to perform operations including: receiving the propellant from the propulsion source; responsive to receiving the propellant, moving the switch; and responsive to moving the switch, activating the light source, wherein the projectile is further deployed from the housing responsive to receiving the propellant from the propulsion source.

In some aspects, the techniques described herein relate to a projectile launcher, wherein the housing includes at least one of a magazine and a cartridge body.

In some aspects, the techniques described herein relate to a projectile launcher, further including a cartridge in which the projectile is received prior to being deployed, wherein the housing includes a housing of the cartridge.

In some aspects, the techniques described herein relate to a projectile launcher, further including at least one of a handle interface, magazine interface, or a cartridge interface through which the propellant is fluidly coupled to the projectile.

In some aspects, the techniques described herein relate to a method performed by a projectile for selectively emitting light from a light source of the projectile, the method including: receiving a propulsion force at a first end of the projectile; coupling the propulsion force to a switch of the projectile; moving the switch responsive to the propulsion force; and activating the light source responsive to moving the switch.

In some aspects, the techniques described herein relate to a method, wherein receiving the propulsion force includes receiving a propellant.

In some aspects, the techniques described herein relate to a method, wherein receiving the propulsion force include coupling the propulsion force to a portion of the switch.

In some aspects, the techniques described herein relate to a method, wherein receiving the propulsion force include coupling the propulsion force to the light source.

In some aspects, the techniques described herein relate to a method, wherein moving the switch includes moving the light source.

In some aspects, the techniques described herein relate to a method, wherein activating the light source includes deploying the projectile from a projectile launcher responsive to the propulsion force.

In some aspects, the techniques described herein relate to a method performed by a projectile for selectively emitting light from a light source of the projectile, the method including: receiving a reset force via a user interface of the projectile; moving a switch of the projectile responsive to the reset force; and deactivating the light source responsive to moving the switch.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. It will be appreciated that examples contained in this disclosure are given by way of explanation, and not of limitation.

What is claimed is:

1. A lighted projectile comprising:
a housing having an opening configured to receive a provided propellant;
a switch comprising a moveable portion disposed within the housing; and
a light source, wherein the moveable portion of the switch is configured to perform operations comprising:
moving in response to the provided propellant being received via the opening of the housing; and
in response to the moving, activating the light source.

2. The lighted projectile of claim 1, wherein the moveable portion comprises the light source.

3. The lighted projectile of claim 2, wherein the moveable portion comprises a weight.

4. The lighted projectile of claim 3, wherein the weight comprises a resilient material disposed in an inner channel of the housing, and wherein the resilient material provides a retention force between the weight and an inner surface of the housing along the inner channel.

5. The lighted projectile of claim 3, wherein the light source comprises a bulb portion and the weight comprises an inner bore in which the bulb portion is disposed.

6. The lighted projectile of claim 1, further comprising at least one contact, wherein the moving comprises electrically coupling the light source to the at least one contact.

7. The lighted projectile of claim 1, wherein the light source comprises at least one connector, wherein the moving comprises moving the at least one connector.

8. The lighted projectile of claim 1, further comprising a projectile head disposed at first end of the projectile, wherein the opening is provided at a second end of the projectile opposite the first end.

9. The lighted projectile of claim 8, wherein the projectile head comprises at least one head channel in which the moveable portion of the switch is received.

10. The lighted projectile of claim 1, further comprising a circuit configured to control an emission characteristic of light emitted from the light source, and wherein the emission characteristic comprises a sequence of activations by which the light is emitted.

11. The lighted projectile of claim 8, wherein the projectile head comprises at least one head cavity, and wherein the projectile comprises at least one power supply disposed in the at least one head cavity.

12. The lighted projectile of claim 8, wherein the projectile head comprises a fastener disposed at a first end of the projectile head opposite a second end of the projectile head at which the projectile head is coupled to the housing.

13. The lighted projectile of claim 1, wherein the light source is configured to emit infrared light.

14. The lighted projectile of claim 1, further comprising a user interface extending through at least one side opening of the housing.

15. The lighted projectile of claim 14, wherein the operations further comprise:
moving in a response to a reset force received via the user interface; and
responsive to moving in response to the reset force, deactivating the light source.

16. The lighted projectile of claim 14, wherein the light source comprises two electrical connectors and the user interface is disposed between the two electrical connectors.

17. The lighted projectile of claim 1, further comprising a cavity fluidly coupled to the opening, wherein the moveable portion is disposed on a first side of the cavity opposite a second side of the cavity at which the opening is fluidly coupled to the cavity.

18. A method performed by a projectile for selectively emitting light from a light source of the projectile, the method comprising:
receiving a propulsion force at a first end of the projectile;
coupling the propulsion force to a switch of the projectile;
moving the switch responsive to the propulsion force; and
activating the light source responsive to moving the switch.

19. The method of claim 18, wherein moving the switch comprises moving the light source.

20. A method performed by a projectile for selectively emitting light from a light source of the projectile, the method comprising:
receiving a reset force via a user interface of the projectile;
moving a switch of the projectile responsive to the reset force; and
deactivating the light source responsive to moving the switch.
